(19) United States
(12) Patent Application Publication
(10) Pub. No.: US 2022/0204187 A1
(43) Pub. Date: Jun. 30, 2022

(54) CAPTURE SYSTEM ADAPTED TO CAPTURE ORBITAL OBJECTS, IN PARTICULAR FOR DEORBITING PURPOSES

(71) Applicant: Ecole Polytechnique Federale de Lausanne (EPFL), Lausanne (CH)

(72) Inventors: Muriel Richard-Noca, Pampigny (CH); Pierre-Alain Mausli, Cheseaux-Lausanne (CH); Michael Pellet, Le Locle (CH)

(21) Appl. No.: 17/438,167

(22) PCT Filed: Mar. 1, 2019
(86) PCT No.: PCT/IB2019/051666

§ 371 Date: Sep. 10, 2021

(51) Int. Cl. B64G 1/22; B64G 1/64

(52) U.S. Cl. CPC B64G 1/222; B64G 1/646

(57) ABSTRACT

A capture system to capture orbital objects for deorbiting purposes and including a deployable capture structure deployable between a standby configuration and a fully deployed open configuration to receive/capture a selected orbital object, a deployment platform, and a closing mechanism designed to close the capture structure around the orbital object. The capture structure includes a plurality of foldable sheet-like structures, each reversibly foldable and unfoldable as a function of deployment of the capture structure, and having a first configuration wherein the foldable sheet-like structure is folded on itself to form the standby configuration, and at least a second configuration wherein the foldable sheet-like structure is unfolded and extended to form the fully deployed open configuration. Each foldable sheet-like structure exhibits a fold pattern defining an alternation of convex and concave sections in the second configuration adapted to automatically fold one on top of the other upon retracting the capture structure.

### TECHNICAL FIELD

The present invention generally relates to a capture system adapted to capture orbital objects, namely objects orbiting Earth, in particular for deorbiting purposes.

### BACKGROUND OF THE INVENTION

Orbital debris are becoming an increasingly problematic issue for satellite launches and space missions. Most of the work during the last decades focussed on debris avoidance prediction and debris monitoring, but most of, if not all major space agencies are now claiming the need for active debris removal (ADR). In 2011, about 14'000 debris larger than 10 cm were catalogued in Low Earth Orbit (LEO), and about 2'000 of these were remains of launch vehicles and 10'000 were originating from non-operational satellites.

One particularly noticeable event in recent years was the accidental collision on Feb. 10, 2009 between two artificial satellites, the Iridium 33 and Kosmos-2251 communication satellites launched respectively in 1997 and 1993. At the time of the collision, the Iridium 33 was still operational, while the Kosmos-2251 reportedly went out of service in 1995, two years after its launch. This was the first hypervelocity collision to be reported between two artificial satellites. The collision destroyed both satellites and generated a considerable amount of orbital debris. The NASA estimated in 2011 that this particular satellite collision, alone, created more than 2'000 debris larger than 10 cm, and many smaller ones (see e.g. Orbital Debris, Quarterly News, Volume 15, Issue 3, July 2011).

Several initiatives have been launched in recent years to study possible solutions for active debris removal (ADR), amongst which the CleanSpace One (CSO) project run under the supervision of the École Polytechnique Fédérale de Lausanne (EFPL). The motivation behind the CSO project is to advance technology readiness levels and start mitigating the impact on the space environment by acting responsibly and actively removing debris from orbit. The main objectives of the CSO project are to raise awareness of the orbital debris problem, develop and test technologies for non-cooperative rendezvous, and, as a demonstration, deorbit the SwissCube-1, a Swiss satellite operated by EPFL until December 2011. SwissCube-1 is a one-unit CubeSat (U-class spacecraft) that weighs less than 1 kg and has dimensions of the order of 100×100×113.5 mm³, as well as VHF and UHF communication antennas deployed to a length of the order of 610 mm and 180 mm, respectively.

As part of the CSO project, launched in 2012, a prototype capture system was developed by EPFL to provide a spacecraft (or “CSO chaser”) capable of catching the SwissCube-1 and removing it from orbit.

A first iteration of the CSO capture system is disclosed in “Developing a reliable capture system for CleanSpace One”, Muriel Richard-Noca et al., 67th International Astronautical Congress (IAC), Guadalajara, Mexico, Sep. 26-30, 2016, IAC-16.A6.5.2, paper ID 35817 (hereinafter referred to as [Richard-Noca2016]), and a second iteration thereof in “Simulation and prototyping of the CleanSpace One capture system”, Xavier Collaud et al., 68th International Astronautical Congress (IAC), Adelaide, Australia, Sep. 25-29, 2017, IAC-17-A6.6.5, paper ID 36911 (hereinafter referred to as [Collaud2017]), both of which publications are hereby incorporated by reference in their entirety.

The two iterations of the CSO capture system disclosed in [Richard-Noca2016] and [Collaud2017] are based on a common system architecture including three main elements, namely (i) a so-called “Pac-Man” net, (ii) a deployment platform comprising multiple (namely five) deployments units (DUs) for the deployment of deployable booms supporting the “Pac-Man” net, and (iii) a closing mechanism. The “Pac-Man” net is attached to and deployed by five bi-stable reelable composite (BRC) booms. The BRC booms and net jointly form, upon being deployed and opened, an opening at the entry of a capture volume. Each boom is made out of carbon fibre composite and can be retracted or extended by a corresponding one of the deployment units by rolling on or unrolling from a spool. The five deployment units are attached to the CSO chaser's X+ face in accordance with a pentagonal arrangement around a centrally-located sensor system used for the tracking and rendezvous operations. Each deployment unit is furthermore configured to be pivotable about the axis of the spool to orient the boom and generate the closing operation. A first actuating drive, common to all deployment units, is used to control deployment of the deployable booms, and a second actuating drive, likewise common to all deployments units, is used to control the opening and closing of the deployable booms.

FIGS. 11A-F are illustrations of the CSO capture system, generally designated by reference numeral 1, as disclosed in [Richard-Noca2016] and [Collaud2017]. Reference numeral 10 generally designates the aforementioned “Pac-Man” net, which is deployed by a deployment platform 200 comprising five deployment units 210 (210.1 to 210.5 in FIG. 11E) each comprising a deployable BRC boom 250. Reference numerals 11 and 12 (see especially FIGS. 11A and 11B) respectively designate lower and upper telescopic stiffening structures used to guide the net 10 upon being deployed. As this is visible on FIG. 11A, the net 10 is attached at an upper end to a distal end of each of the booms 250 and partly woven about the booms 250. The net 10 is further attached at a lower end to a base of the deployment platform 200. A protective net 15 (see especially FIGS. 11B and 11F) is also provided and attached to the base of the deployment platform 200 to act as protection for the actuating part of the deployment units 210 as well as for the sensor system that is located in a central portion of the deployment platform 200, inside the pentagonal arrangement formed by the deployment units 210 (210.1 to 210.5).

As schematically depicted in FIG. 11E, deployment of the BRC booms 250 is controlled by a first actuating drive 205 that drives rotational movement of a spool 211 of each deployment unit 210.1-210.5 via a series of (namely four) flexible axes 206 interconnecting the deployment units 210.1-210.5, causing rolling or unrolling of the BRC booms 250. Pivoting of each deployment unit 210.1-210.5 about the axis of the spool 211 (and therefore closing or opening of the CSO capture system 1) is controlled by the closing mechanism 300, which includes a second actuating drive 305 that is drivingly connected to the deployment units 210.1-210.5 via a cable 306 guided by pulleys 307. The cable 306 is attached to a portion 215A of an outer shell 215 of each deployment unit 210.1-210.5 to cause pivotal movement thereof about the axis of the spool 211. Secured to the shell 215 is a boom guide support 216 that is accordingly pivoted together with the shell 215, causing pivotal movement of each boom 250 and therefore closing or opening of the net 10. Reference numeral 217 in FIG. 11E designates a pair of mounting supports for mounting of the deployment units 210.1-210.5 on a surface of the deployment platform 200.

Tests realized with the prototype of the CSO capture system have highlighted potential issues resulting from the use of the aforementioned “Pac-Man” net, including undesired entanglement of the net with other components of the CSO capture system, especially parts of the deployment units. Furthermore, undesired boom deflections or deformations are caused by manufacturing tolerances and the net geometry. In addition, as the net is basically free to move in unsupported areas, it is not possible to precisely control the geometry and behaviour of the net upon being deployed or retracted. These issues could especially be problematic in that an essential part of the relevant functional requirements and specifications of the CSO capture system is the ability to repeat the capture operation in case of a capture failure, meaning that operation of the capture system must be reversible.

There is therefore a need for an improved solution.

### SUMMARY OF THE INVENTION

A general aim of the invention is to remedy the above-noted shortcomings of the prior art.

More precisely, an aim of the present invention is to provide a capture system whose capture structure is fully reversibly deployable so that the capture system can perform multiple capture operations if need be.

A further aim of the invention is to provide such a capture system that is more robust and reliable, while remaining of reasonably simple and cost-efficient construction.

Yet another aim of the invention is to provide such a capture system that is ideally suited to carry out capture of an orbital object, in particular for deorbiting purposes.

An aim of the invention is also to provide such a capture system that can adequately be affixed to an orbit chaser for the purpose of carrying out deorbiting missions.

Yet another aim of the invention is to provide a suitable method of capturing an orbital object as well as of deorbiting such an orbital object.

These aims are achieved thanks to the solutions defined in the claims. There is accordingly provided a capture system, the features of which are recited in claim 1, namely a capture system adapted to capture orbital objects, in particular for deorbiting purposes, comprising:
a deployable capture structure designed to be deployable between a standby configuration and a fully deployed open configuration, in which the capture structure defines a capture volume with an opening dimensioned to receive and capture a selected orbital object;
a deployment platform designed to deploy the capture structure; and
a closing mechanism designed to close the capture structure around the selected orbital object located within said capture volume.

According to the invention, the capture structure consists of a capture envelope comprising a plurality of foldable sheet-like structures each configured to be reversibly foldable and unfoldable as a function of deployment of the capture structure, each foldable sheet-like structure being designed to take a first configuration, in which the foldable sheet-like structure is folded on itself to form the standby configuration of the capture structure, and at least a second configuration, in which the foldable sheet-like structure is unfolded and extended to form the fully deployed open configuration of the capture structure. Each foldable sheet-like structure exhibits a fold pattern defining an alternation of convex and concave sections in the second configuration, which convex and concave sections are adapted to automatically fold one on top of the other upon retracting the capture structure.

A considerable advantage of the invention resides in that each foldable sheet-like structure forms a robust yet flexible structure that is reliably retractable and deployable, in a fully reversible manner. The fold pattern furthermore has the effect of imparting a certain level of structural stiffness to each sheet-like structure when being deployed, which favours a more precise control of the overall geometry of the resulting capture envelope. As a matter of fact, the entire kinematics of the capture structure during deployment and retraction fully remains under control, and no entanglement issues accordingly arise.

According to a particularly advantageous embodiment of the invention, the fold pattern is selected to allow the foldable sheet-like structure to be flat folded, which leads to a very compact arrangement of the capture structure in a retracted, undeployed state.

In the context of this preferred embodiment, the fold pattern may in particular be selected to define a succession of foldable structural bands extending transversely to a direction of deployment of the foldable sheet-like structure, each of the foldable structural bands exhibiting a plurality of mountain folds and a plurality of valley folds joining at defined vertices located along borders of said foldable structural bands, which mountain folds and valley folds extend across each of the foldable structural bands and along the borders between the foldable structural bands to form essentially triangular or trapezoidal band sections.

The succession of foldable structural bands may especially include an alternation of first and second foldable structural bands, each of the first foldable structural bands being a mirrored image of each of the second foldable structural bands.

By way of preference, the plurality of mountain folds and the plurality of valley folds form a plurality of trapezoidal band sections along each of the foldable structural bands, including acute and/or obtuse trapezoids. In particular, the plurality of mountain folds and the plurality of valley folds may form a succession of trapezoidal band sections and triangular band sections.

Advantageously, each of the foldable sheet-like structure is configured in such a way as to be generally curved outwardly when in the fully deployed open configuration of the capture structure. Such outward curvature can easily be produced thanks to an appropriate design of the fold pattern.

In accordance with another aspect of the invention, the deployment platform comprises at least three deployment units positioned in a polygonal arrangement, each deployment unit being configured to allow deployment of a deployable boom causing deployment of the capture structure, and the capture envelope comprises at least three of said foldable sheet-like structures, each foldable sheet-like structure being coupled between an associated pair of said deployable booms to form a peripherally closed capture envelope. In particular, three to five deployment units and a corresponding number of said foldable sheet-like structures could be provided.

The number of deployment units can especially be reduced to only three, which reduces the complexity and the costs of the capture system. In this particular context, a first foldable sheet-like structure is coupled between the deployable boom of a first deployment unit and the deployable boom of a second deployment unit, a second foldable sheet-like structure is coupled between the deployable boom of the second deployment unit and the deployable boom of a third deployment unit, and a third foldable sheet-like structure is coupled between the deployable boom of the third deployment unit and the deployable boom of the first deployment unit.

Advantageously, a nominal unfolded width of each foldable sheet-like structure at a lower end portion thereof may be smaller than a nominal unfolded width of each foldable sheet-like structure at an upper end portion. This further improves integration and compactness of the capture structure.

Furthermore, first and second lateral ends of each foldable sheet-like structure may each be provided with a plurality of eyelets distributed along a length thereof, which plurality of eyelets is adapted to slide along the first, respectively second deployable boom. This likewise ensures adequate support of each foldable sheet-like structure to the associated deployable booms and a robust deployment of the capture structure.

In this latter context, an end portion of each deployable boom may especially be curved inwardly and a distribution of the plurality of eyelets along the length of the first and second lateral ends of each foldable sheet-like structure may be such that a higher density of eyelets is provided at a portion of the first and second laterals ends coinciding with the inwardly curved end portion of each deployable boom.

By way of preference, each foldable sheet-like structure may comprise attachment strips extending away from said first and second lateral ends and forming an integral part of the foldable sheet-like structure, which attachment strips are secured to said eyelets. Each attachment strip can in particular be secured to an associated one of said eyelets by passing an end portion of the attachment strip through the associated eyelet and by weaving the end portion of the attachment strip through at least two successive apertures formed on the foldable sheet-like structure next to the attachment strip.

Moreover, a lower end portion of each foldable sheet-like structure may be secured to a support element, which support element is secured to a base of the deployment platform.

Preferably, the deployment platform further comprises a common deployment drive unit to control deployment of all of the deployable booms. The common deployment drive unit may in particular be coupled to a first one of the deployment units and the remaining deployment units may be drivingly connected to said first deployment unit in sequence via flexible axes.

Advantageously, each deployable boom may consist of a bi-stable reelable composite (BRC) boom adapted to be selectively rolled on or unrolled from a spool.

By way of preference, the closing mechanism is configured to pivot each deployment unit about a pivot axis. In particular, the pivot axis may coincide with an axis of rotation of the aforementioned spool.

In particular, the closing mechanism can comprise a common closing drive unit to control pivotal movement of all of the deployment units about their respective pivot axis. The common closing drive unit may especially control pivotal movement of the deployment units via a cable and pulley arrangement.

In accordance with a particular preferred embodiment of the invention, the capture system is configured to initially take a stowed launch position, in which each foldable sheet-like structure takes a corresponding stowed configuration, and to be subsequently switched to a standby position, in which each foldable sheet-like structure takes the standby configuration.

The aforementioned closing mechanism may especially be configured to cause switching of the capture system from the stowed launch position to the standby position by pivotal movement of each deployment unit. In this context, each deployment unit may further comprise a retaining mechanism configured to hold the foldable sheet-like structures in the stowed configuration. This retaining mechanism may in particular comprise one or more retaining members each configured to hold a selected portion of the foldable sheet-like structures in the stowed configuration, each retaining member being configured to automatically release the selected portion of the foldable sheet-like structures upon switching from the stowed configuration to the standby configuration. The retaining mechanism may also comprise one or more finger members each configured to maintain a selected portion of the foldable sheet-like structures in the stowed configuration. Each finger member may further be configured to assist switching of the foldable sheet-like structure from the stowed configuration to the standby configuration.

In accordance with a further embodiment of the invention, the capture system of the invention may further comprise a sensor system designed to assist tracking and rendezvous operations with the selected orbital object. The sensor system may especially be located in a central portion of the deployment platform along a centreline of the capture structure. In this context, the standby configuration is preferably an open configuration, in which the closing mechanism is operated to open the capture structure and so that the capture structure does not obstruct a field of view of the sensor system.

In this latter context, a distal end of each deployable boom is preferably provided with a holding member comprising first and second arms that are configured to hold an associated pair of said foldable sheet-like structures in the standby configuration and prevent obstruction of the field of view of the sensor system. The first arm of the holding member is configured to hold a first upper portion of a first foldable sheet-like structure of said associated pair of foldable sheet-like structures in the standby configuration, while the second arm of the holding member is configured to hold a second upper portion of a second foldable sheet-like structure of said associated pair of foldable sheet-like structures in the standby configuration. This ensures that the foldable sheet-like structures are appropriately held in the standby configuration and do not obstruct the field of view of the sensor system.

By way of preference, each foldable sheet-like structure is made of a sheet or foil of flexible material. In particular, each foldable sheet-like structure may be made of polyimide (PI) material, such as Kapton, or of polyethylene terephthalate (PET) material, in particular biaxially-oriented polyethylene terephthalate (BoPET) material, such as Mylar.

Furthermore, each foldable sheet-like structure is preferably coated for protection against corrosion by atomic oxygen (ATOX). Each foldable sheet-like structure may especially be aluminium coated.

A thickness of each foldable sheet-like structure may further be comprised between 100 μm and 150 μm.

Also claimed is a spacecraft as defined in claim 39 comprising a capture system in accordance with the invention. In this context, the capture system is preferably located on the X+ face of the spacecraft.

There is also provided a method of capturing an orbital object by means of the aforementioned spacecraft, the features of which capture method are recited in claim 41, namely such a method comprising the following steps:

(a) operating the capture system to bring the capture structure to the standby configuration;

(b) locating a selected orbital object to be captured and manoeuvring the spacecraft to perform a rendezvous with the selected orbital object;

(c) operating the capture system to bring the capture structure to the fully deployed open configuration;

(d) manoeuvring the spacecraft to bring the selected orbital object inside the capture volume of the capture structure;

(e) operating the capture system to close the capture structure;

(f) operating the capture system to retract the capture structure;

(g) checking proper capture of the selected orbital object by the capture system; and

(h) in case of a capture failure, operating the capture system to open the capture structure and repeating steps (c) to (h).

Preferably, prior to a first capture attempt, the deployment platform is operated at step (c) to bring the capture structure from the standby configuration to a partly deployed open configuration and then from the partly deployed open configuration to the fully deployed open configuration. Furthermore, the closing mechanism is operated at step (e) to bring the capture structure from the fully deployed open configuration to a fully deployed closed configuration, the deployment platform is operated at step (f) to bring the capture structure from the fully deployed closed configuration to a partly retracted closed configuration, and, in case of capture failure, the closing mechanism is operated at step (h) to bring the capture structure from the partly retracted closed configuration back to the partly deployed open configuration.

Advantageously, during launch of the spacecraft, the capture system may initially be configured to take a stowed launch position, in which each foldable sheet-like structure takes a corresponding stowed configuration, and the capture system may subsequently be reconfigured to switch the capture system from the stowed launch position to a standby position, in which each foldable sheet-like structure takes the standby configuration.

There is also provided a method of deorbiting an orbital object, the features of which are recited in claim 44, namely such a method comprising capturing the orbital object by means of a spacecraft in accordance with the aforementioned capture method and manoeuvring the spacecraft to deorbit the captured orbital object.

Also claimed is the use of a deployable capture structure to capture orbital objects, in particular for deorbiting purposes, the features of which are recited in claim 45, namely such use of a deployable capture structure which consists of a capture envelope comprising a plurality of foldable sheet-like structures each configured to be reversibly foldable and unfoldable as a function of deployment of the capture structure, each foldable sheet-like structure being designed to take a first configuration, in which the foldable sheet-like structure is folded on itself to form a standby configuration of the capture structure, and at least a second configuration, in which the foldable sheet-like structure is unfolded and extended to form a fully deployed open configuration of the capture structure. Each foldable sheet-like structure exhibits a fold pattern defining an alternation of convex and concave sections in the second configuration, which convex and concave sections are adapted to automatically fold one on top of the other upon retracting the capture structure.

Further advantageous embodiments of the invention form the subject-matter of the dependent claims and are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a schematic perspective view of a capture system in accordance with the invention, illustrating a deployable capture structure thereof deployed in a fully deployed open configuration;

FIG. 1A is a schematic side view of the capture volume resulting from full deployment of the capture structure;

FIG. 2 is a partial perspective view of one deployment unit of the capture system's deployment platform in accordance with an embodiment of the invention, which deployment unit is configured to allow deployment of a deployable boom consisting of a bi-stable reelable composite (BRC) boom;

FIG. 2A is a photographic illustration of the bi-stable reelable composite (BRC) boom;

FIG. 2B is a schematic functional diagram of the relevant components of the deployment unit of FIG. 2;

FIG. 3 is a schematic illustration of a spacecraft, or “orbital chaser”, comprising a capture system according to the invention, the capture structure of which is not illustrated for the sake of explanation;

FIG. 4 is a schematic illustration of a preferred deployment scenario of the orbital chaser and associated capture system during capture of a selected orbital object, here shown as the SwissCube-1;

FIG. 5A is a schematic illustration of a foldable sheet-like structure and associated fold pattern illustrating the underlying principle used in the context of the present invention for the purpose of designing a corresponding foldable sheet-like structure to act as part of the capture structure of the capture system;

FIG. 5B is a schematic illustration of the foldable sheet-like structure of FIG. 5A folded into a flat configuration;

FIG. 5C is a schematic perspective view of the foldable sheet-like structure of FIG. 5A in a partly folded/unfolded configuration;

FIG. 6A is a schematic illustration of a foldable sheet-like structure exhibiting a defined fold pattern in accordance with one embodiment of the invention;

FIG. 6B is a schematic illustration of the foldable sheet-like structure of FIG. 6A folded into a flat configuration;

FIG. 6C is a schematic illustration of a foldable sheet-like structure exhibiting a defined fold pattern in accordance with another embodiment of the invention;

FIG. 7 is a schematic illustration of various examples of foldable sheet-like structures in accordance with embodiments of the invention;

FIG. 8A is a photographic illustration of a prototype of a foldable sheet-like structure as mounted between two deployed BRC booms, shown in an open configuration;

FIG. 8B is a photographic illustration of the prototype of FIG. 8A, shown in a closed configuration;

FIG. 9A is a photographic illustration of a portion of a lateral end of a foldable sheet-like structure according to one embodiment of the invention, which lateral end is provided with an attachment strip for attachment to an associated eyelet;

FIG. 9B is a photographic illustration of the attachment strip of FIG. 9A attached to the associated eyelet;

FIG. 9C is a schematic cross-sectional view of the attachment strip as attached to the eyelet;

FIG. 10A is a top view of a rendering of a capture system in accordance with another embodiment of the invention, the capture system being shown in a stowed launch position;

FIG. 10B is an enlarged, partial perspective view of the capture system of FIG. 10A;

FIG. 10C is a perspective view of one of the deployment units of the capture system of FIG. 10A, likewise shown in a stowed launch position;

FIG. 10D is a top view of the capture system of FIG. 10A, following switching of the capture system from the stowed launch position to a standby position;

FIG. 10E is a perspective view of the capture system of FIG. 10D, in the standby position;

FIG. 10F is a partial perspective view, taken from the side, of the capture system of FIG. 10D, in the standby position;

FIG. 11A is a photographic illustration of a prototype of the known CSO capture system as disclosed in [Richard-Noca2016] and [Collaud2017];

FIG. 11B is a photographic illustration of the prototype of FIG. 11A without the so-called “Pac-Man” net;

FIG. 11C is a photographic illustration of the prototype of FIG. 11A shown in a stowed configuration;

FIG. 11D is a photographic illustration of the prototype of FIG. 11A in the stowed configuration as seen from above;

FIG. 11E is a schematic drawing of the deployment platform of the prototype of FIG. 11A showing the individual deployment units in a stowed position; and

FIG. 11F is a photographic illustration of the prototype of FIG. 11A shown in a standby configuration.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the embodiments disclosed herein.

As described herein, when two or more parts or components are described as being connected, attached, secured or coupled to one another, they can be so connected, attached, secured or coupled directly to each other or through one or more intermediary parts.

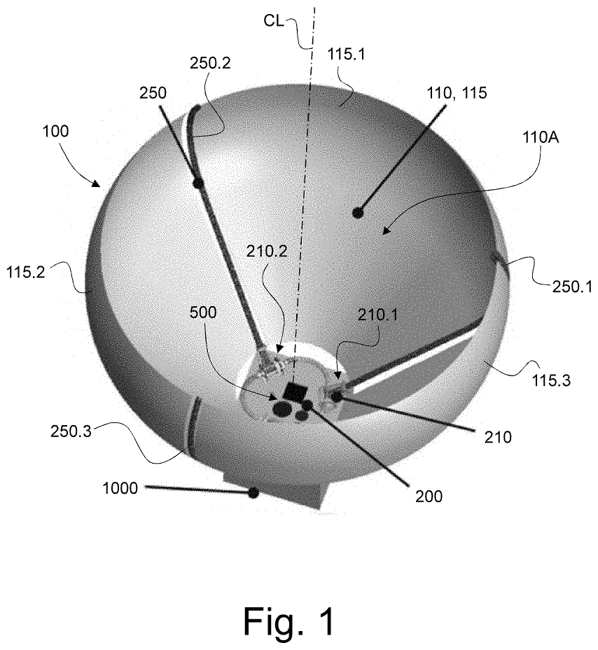

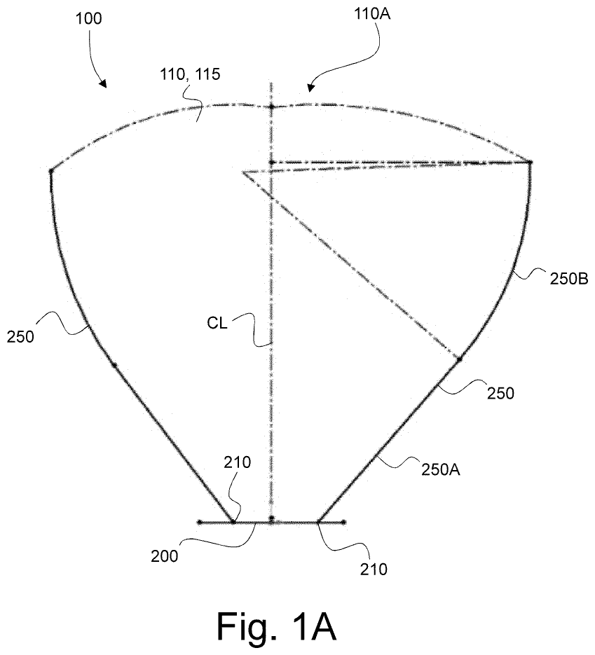

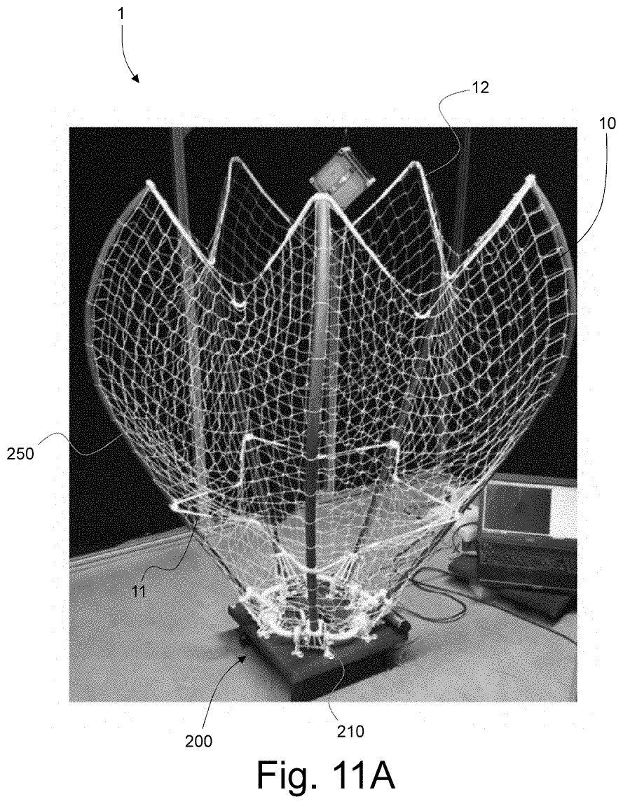

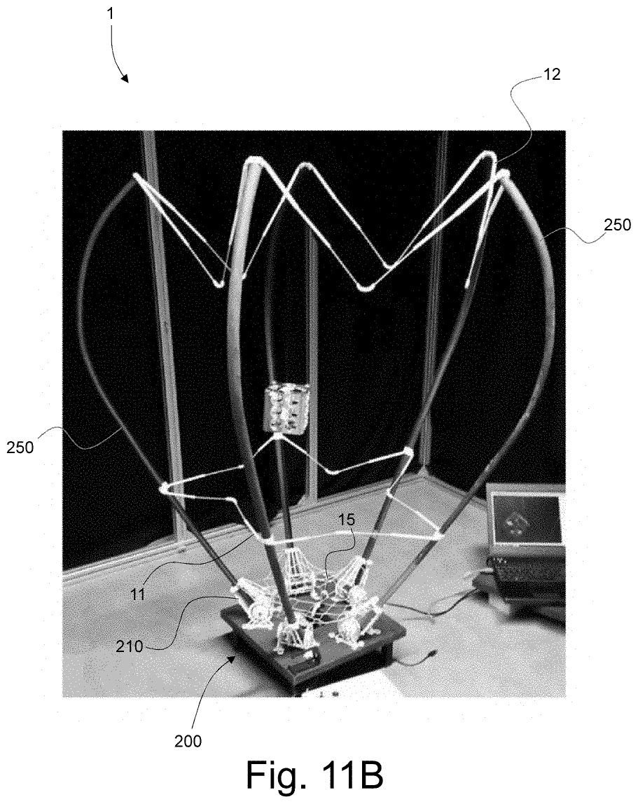

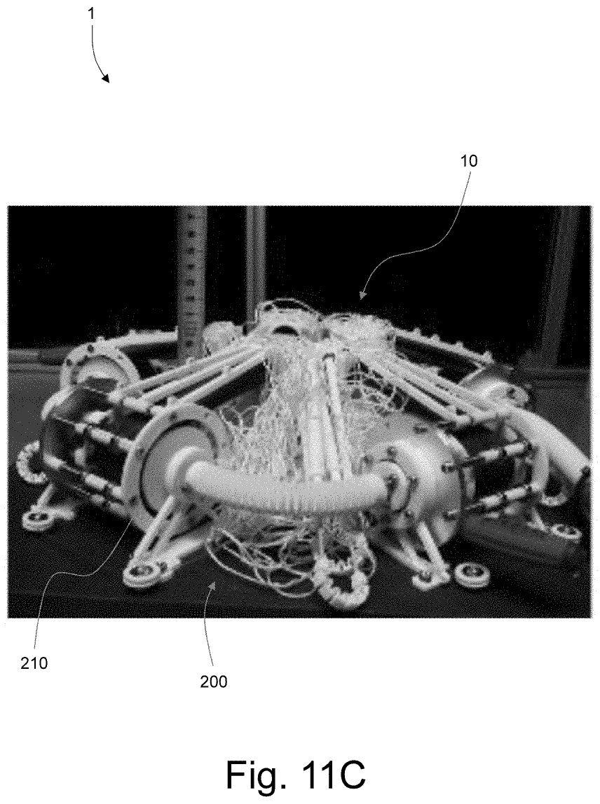

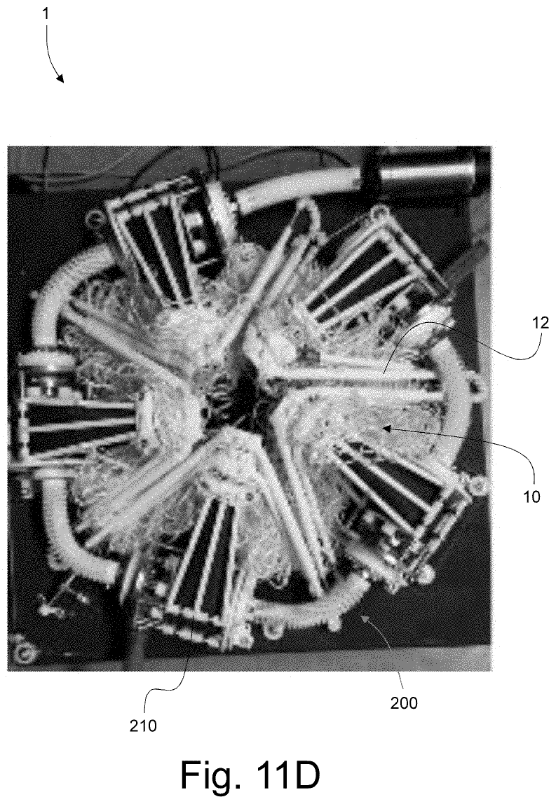

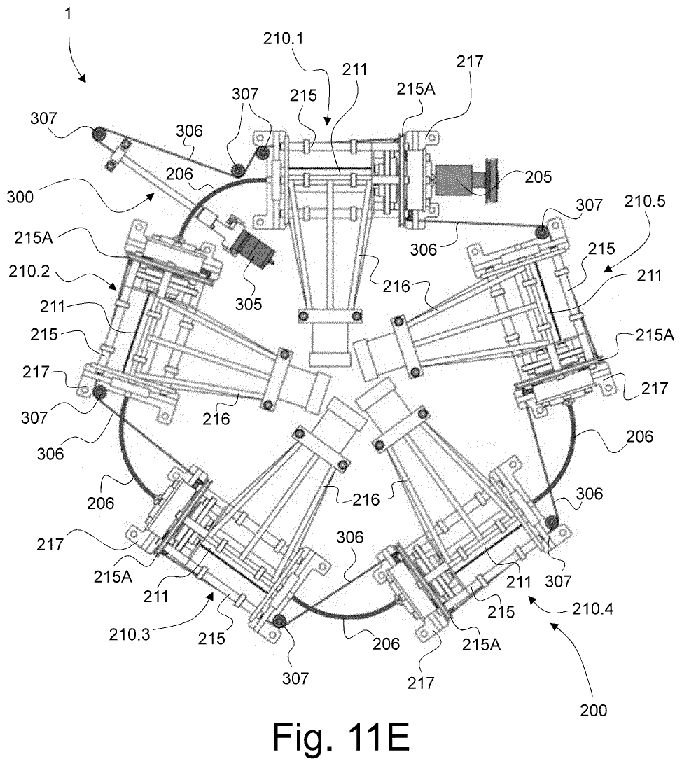

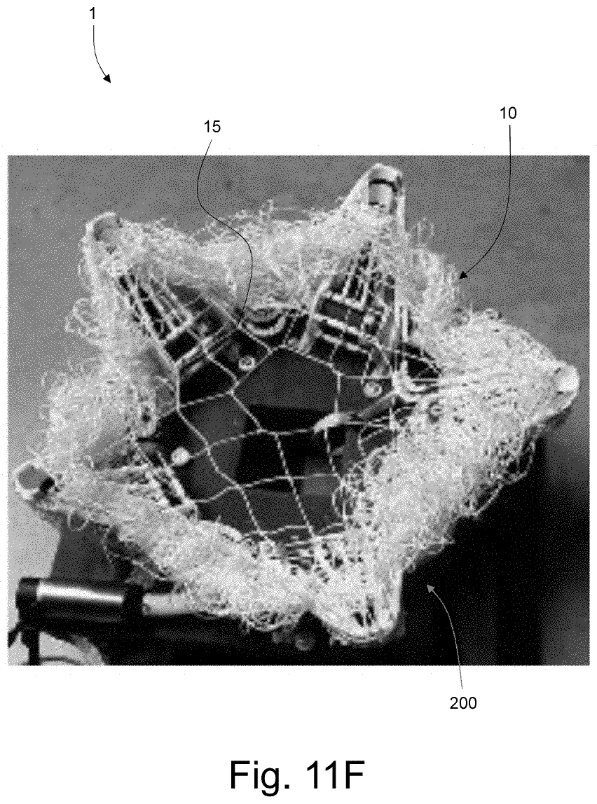

FIGS. 1 and 1A are schematic illustrations of an embodiment of a capture system in accordance with the present invention, as generally designated by reference numeral 100. In a manner similar to the known CSO capture system discussed in the preamble hereof (see again FIGS. 11A-F), the capture system 100 comprises a deployable capture structure 110 here shown in a fully deployed open configuration, in which the capture structure 110 defines a capture volume with an opening 110A dimensioned to receive and capture a selected orbital object. While not specifically shown in FIGS. 1 and 1A, the capture structure 110 is designed to be deployable between a standby configuration and the illustrated fully deployed open configuration. As this will be appreciated from reading the following description, the capture structure 110 may take further configurations, including one or more intermediate configurations between the standby and fully deployed open configurations, as well as—preferably—a stowed launch configuration adopted during launch of the spacecraft onto which the capture system is affixed. The capture structure 110 is additionally configured to be selectively closed and opened.

Embodiments of the invention will be described in the particular context of the capture of the SwissCube-1, but it is to be understood that the capture system of the present invention is not limited to any particular type of orbital object. Evidently, the geometry and dimensions of the capture system and of the capture structure shall be adapted to the geometry and dimensions of the orbital object to be captured. The SwissCube-1 is a relatively small object, and the capture system 100 shown in the drawings is dimensioned and configured accordingly. Larger orbital objects could be captured using a similar capture system configuration, the dimensions and geometry of which would be adapted accordingly, without this affecting the underlying principles of the capture system as described herein.

The capture system 100 shown schematically in FIGS. 1 and 1A further includes a deployment platform 200 designed to deploy the capture structure 110, and a closing mechanism, not specifically shown in FIGS. 1 and 1A, which closing mechanism is designed to close the capture structure 110 around the selected orbital object located within the capture volume.

Functionally speaking, the deployment platform 200 and the closing mechanism of the capture system 100 may be similar to the deployment platform 200 and the closing mechanism 300 used in connection with the known CSO capture system (see especially FIG. 11E). It shall thus be understood that operation of the deployment platform and of the closing mechanism is fully reversible, i.e. the deployment platform is adapted to deploy, retract and re-deploy the capture structure 110 if need be, while the closing mechanism is similarly adapted to close and re-open the capture structure 110, should it be necessary to carry out multiple capture attempts.

As this will be appreciated from reading the following description, the invention mainly differs from the known CSO capture system in the design and construction of the capture structure 110. This being said, the new capture structure 110 has also led to corresponding adaptations and improvements of the deployment platform and of the closing mechanism, which adaptations and improvements will be discussed hereafter.

Reference numeral 1000 in FIG. 1 generally designates a spacecraft, hereinafter referred to as “orbital chaser” onto which the capture system 100 is affixed. By way of preference, the capture system 100 is provided on the X+ face of the orbital chaser.

As further shown in FIG. 1, a sensor system 500 is also preferably provided to assist tracking and rendezvous operations with the selected orbital object. This sensor system 500 is here shown located in a central portion of the deployment platform 200 along a centreline CL of the capture structure 110.

Referring to FIG. 1, one can note that the deployment platform 200 here comprises three deployment units 210, namely a first deployment unit 210.1, a second deployment unit 210.2 and a third deployment unit 210.3 (not visible in FIG. 1). The deployment units 210.1, 210.2, 210.3 are positioned in a polygonal arrangement (namely a triangular arrangement in the illustrated example) and are each configured to allow deployment of an associated deployable boom 250, namely a first deployable boom 250.1, a second deployable boom 250.2 and a third deployable boom 250.3, respectively.

It will already be appreciated that, in contrast to the known CSO capture system, three deployment units 210 may be sufficient to carry out deployment of the capture structure 110, instead of the five deployment units of the known CSO capture system. This is possible in part due to the particular nature of the capture structure 110 of the invention which is at least partly self-supporting in the deployed configuration. This already illustrates one of the key advantages of the present invention, as detailed below.

This being said, the deployment platform of the capture system of the invention may potentially comprise three or more deployment units. From a more general perspective, the deployment platform 200 may comprise three or four deployment units 210, or potentially even five (or more) if required.

As schematically illustrated in FIG. 1, the capture structure 110 consists of a capture envelope comprising a plurality of, namely three, foldable sheet-like structures (or “foldable foils”) 115, namely a first sheet-like structure 115.1 (positioned between the first and second deployment units 210.1, 210.2 and associated booms 250.1, 250.2), a second sheet-like structure 115.2 (positioned between the second and third deployment units 210.2, 210.3 and associated booms 250.2, 250.3) and a third sheet-like structure 115.3 (positioned between the third and first deployment units 210.3, 210.1 and associated booms 250.3, 250.1). In other words, each foldable sheet-like structure 115.1, 115.2, 115.3 is coupled between an associated pair of deployable booms 250, namely deployable booms 250.1/250.2, 250.2/250.3 and 250.3/250.1, respectively, to form a peripherally closed capture envelope as schematically depicted in FIG. 1.

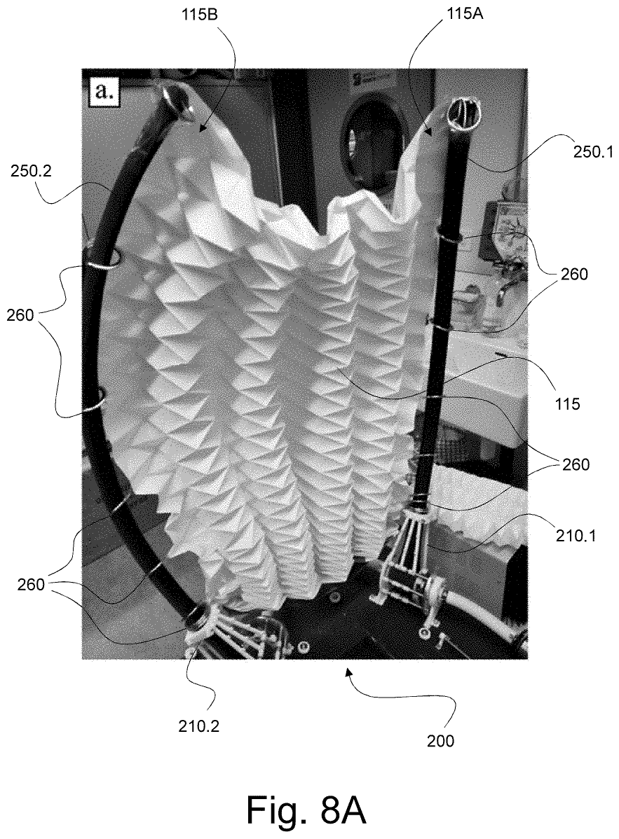

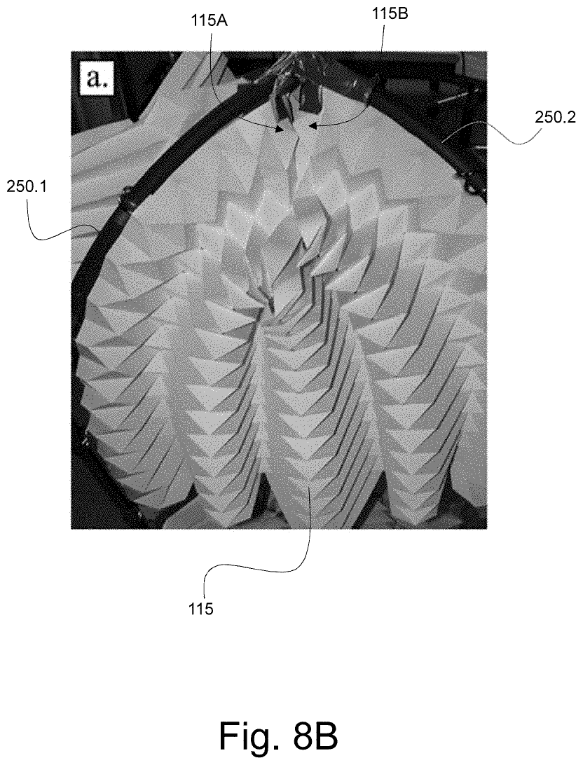

Each foldable sheet-like structure 115 is configured to be reversibly foldable and unfoldable as a function of deployment of the capture structure 110. FIGS. 1 and 1A schematically show the foldable sheet-like structures 115 as curved, smooth structures in the deployed configuration for the purpose of illustration, but it should be understood that each foldable sheet-like structure 115 actually exhibits a fold pattern defining an alternation of convex and concave sections in the deployed configuration, which convex and concave sections are adapted to automatically fold one on top of the other upon retracting the capture structure 110. More representative illustrations of the sheet-like structures 115 in the fully deployed configuration are shown for instance in the photographic illustrations of FIGS. 8A-B.

In accordance with the invention, each foldable sheet-like structure 115 is designed to take a first configuration, in which the foldable sheet-like structure 115 is folded on itself to form the standby configuration of the capture structure 110, and at least a second configuration, in which the foldable sheet-like structure is unfolded and extended to from the fully deployed open configuration of the capture structure 110. It is worth stressing that, in the fully deployed open configuration of the capture structure 110, the foldable sheet-like structures 115 are unfolded and extended in a manner such that they can be folded again. In that respect, the sheet-like structures 115 are not completely unfolded, but retain the distinctive alternation of convex and concave sections as for instance depicted in FIGS. 8A-B. This also provides a certain level of structural stiffness to the sheet-like structures 115, which become in essence self-supporting.

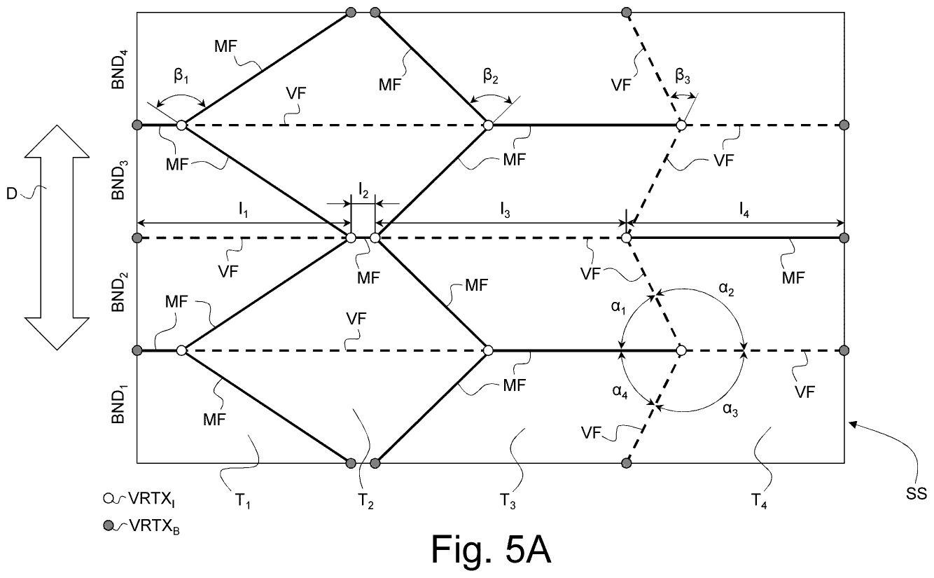

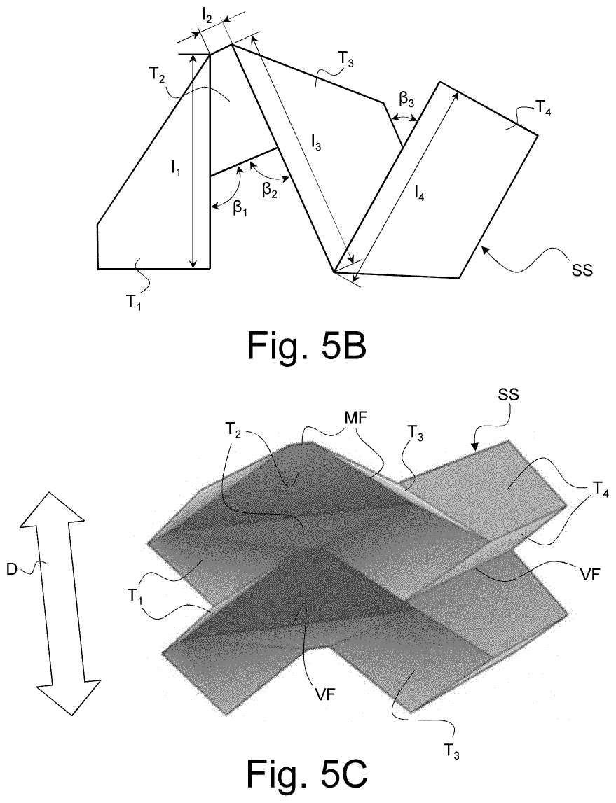

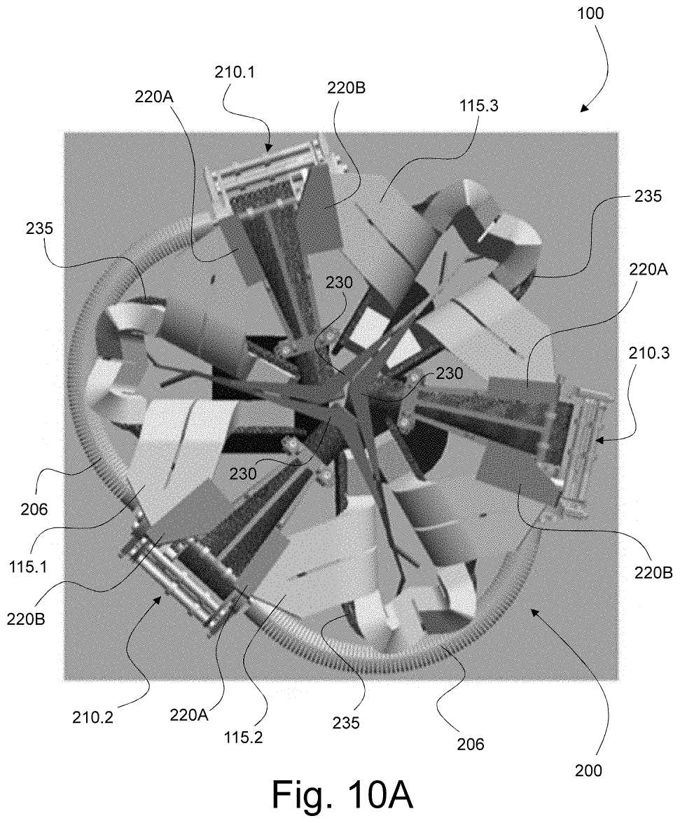

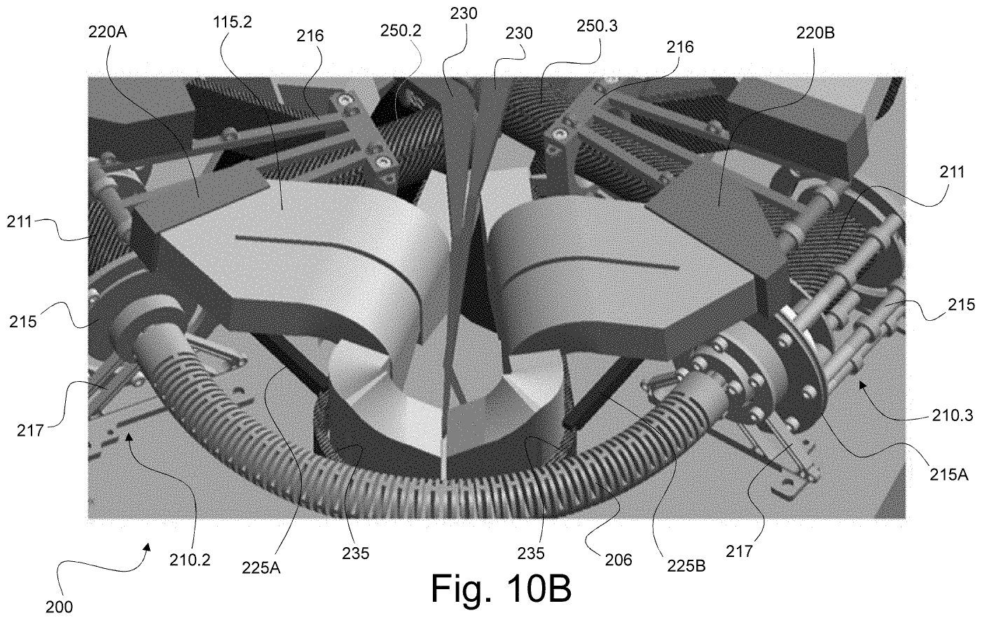

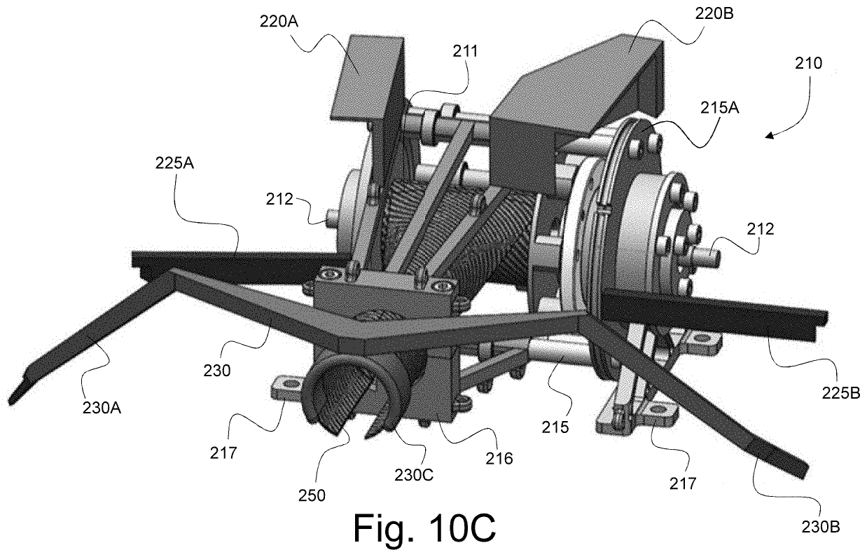

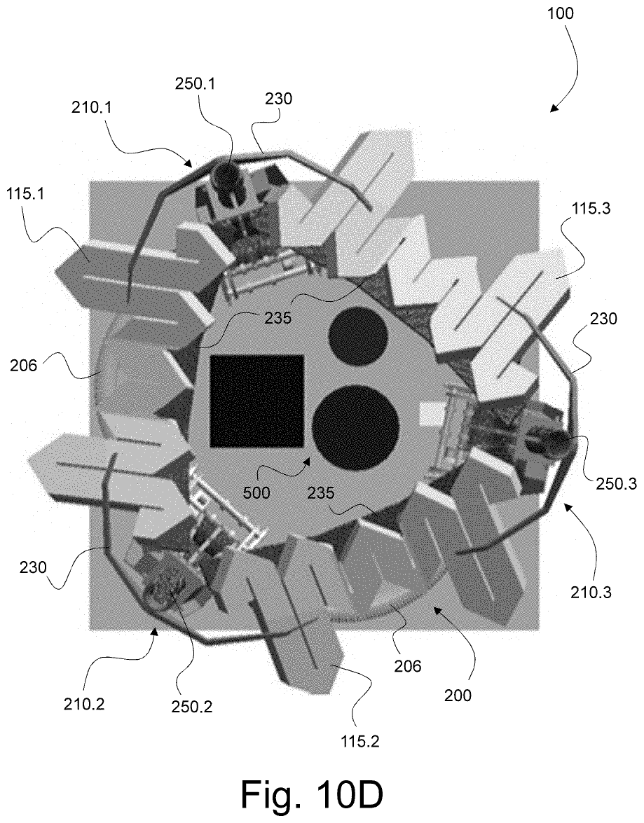

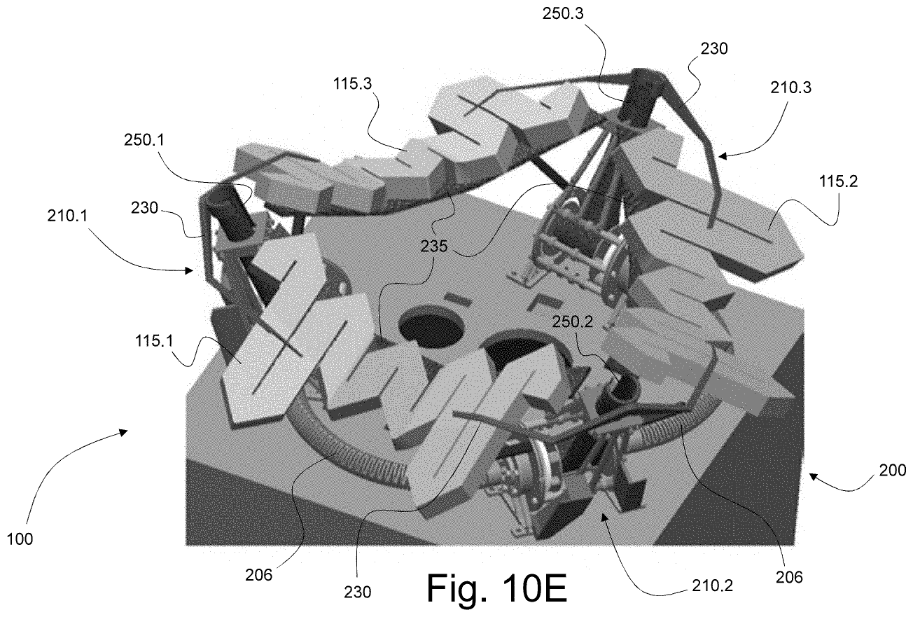

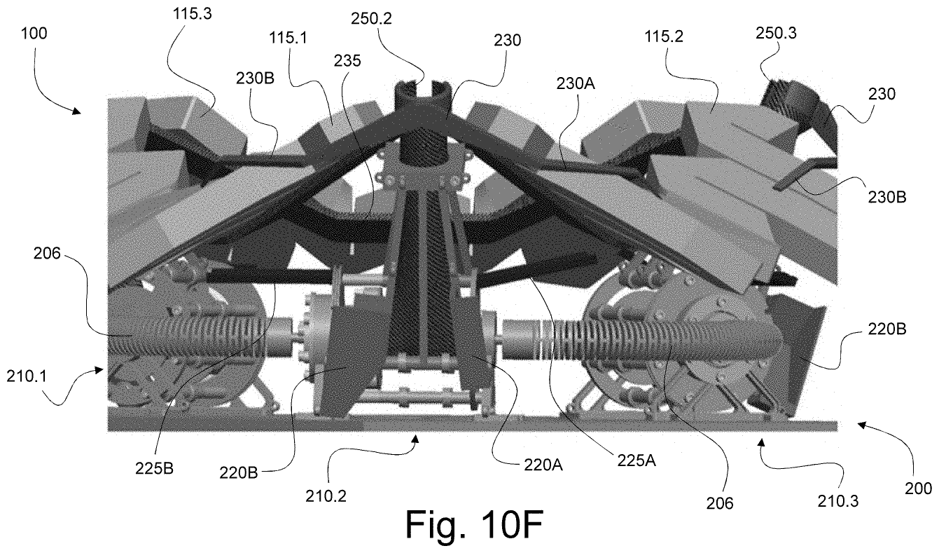

By way of preference, the fold pattern of each foldable sheet-like structure 115 is selected to allow the foldable sheet-like structure 115 to be flat folded. How such a flat fold can be obtained will be explained in greater detail hereafter with reference to FIGS. 5A-C, 6A-C and 7. As this will be appreciated from looking at the embodiments of the invention, the first configuration of each foldable sheet-like structure 115 is not necessarily flat as such (see e.g. FIGS. 10D-F), but the sheet-like structure 115 is folded on itself to form a flat-folded arrangement than can further be curved to conform to the needs. In particular, in the standby configuration of the capture structure 110, each foldable sheet-like structure 115 can be flat folded and slightly curved in the first configuration (as schematically illustrated in FIGS. 10D-F). Furthermore, the capture system 100 can advantageously take a further, stowed launch configuration (see e.g. FIGS. 10A-E), in which each foldable sheet-like structure 115 takes a corresponding stowed configuration where it is still flat folded but further bent and/or curved to occupy less space. This illustrates yet another advantage of the present invention, namely the ability of each foldable sheet-like structure 115 to take multiple configurations meeting different needs, without this compromising control of the actual geometry and deployment behaviour of each foldable sheet-like structure 115.

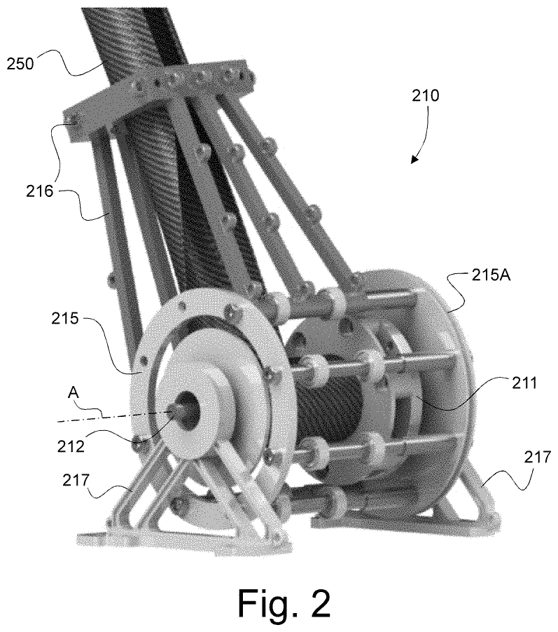

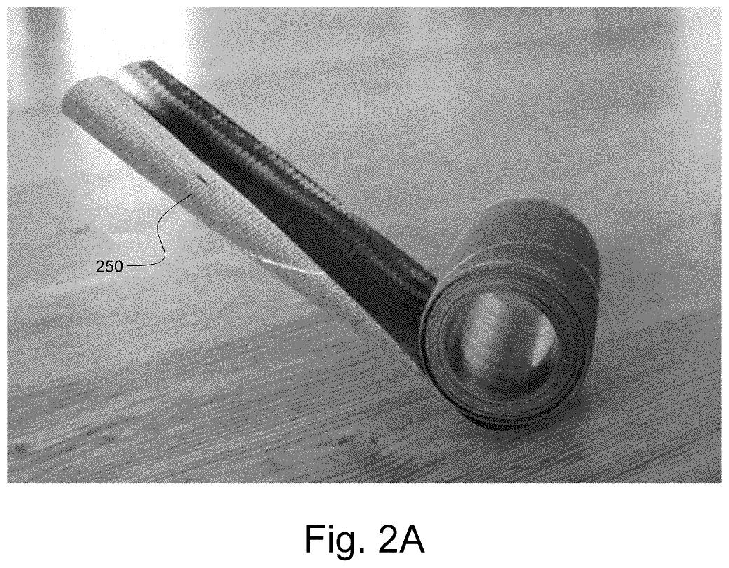

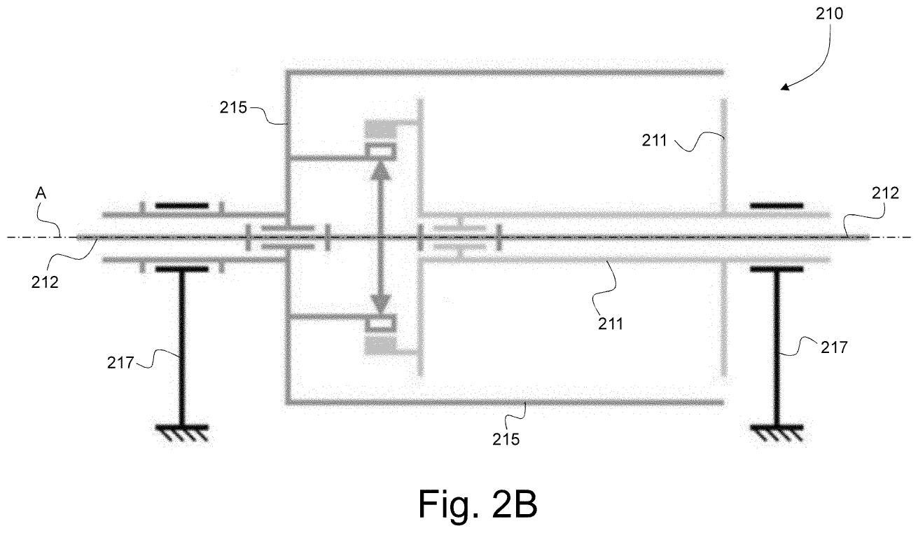

FIG. 2 illustrates an example of a possible deployment unit 210 usable in connection with the invention, which deployment unit 210 is identical to that already described in [Collaud2017]. This deployment unit 210 essentially comprises a pivotable outer shell 215 that is adapted to be pivoted about an axis A (or “pivot axis”) and that is secured to a boom guide support 216 to provide guidance and support for the deployment of the deployable boom 250. The boom 250 itself preferably consists of a bi-stable reelable composite (BRC) boom that is adapted to be selectively rolled on or unrolled from a spool 211. The spool 211 is rotatably supported onto the outer shell 215 to allow rotation of the spool 211 about an axis of rotation that is co-axial with the pivot axis of the outer shell 215 and boom guide support 216. In other words, the pivot axis of the outer shell 215 and associated boom guide support 216 and the axis of rotation of the spool 211 are one and a same axis, namely axis A. Reference numeral 217 in FIG. 2 designates a pair of mounting supports for mounting of the deployment unit 210 on a surface of the deployment platform 200, the outer shell 215 being pivotably supported onto the mounting supports 217.

Reference numeral 212 in FIG. 2 designates a driving shaft of the spool 211 co-axial with axis A. This driving shaft 212 can conveniently be driven into rotation by an associated actuating drive mechanism, which could be similar to that used in connection with the known CSO capture system. More precisely, a common deployment drive unit (e.g. motor) 205, acting as actuating drive controlling deployment of the deployable booms 250 of all deployment units 210, may be provided, which drive unit 205 may likewise be coupled to a first one 210.1 of the deployment units 210, with the remaining deployment units 210.2, 210.3, etc., being drivingly connected to the first deployment unit 210.1 in sequence via flexible axes 206 (see again the driving arrangement shown in FIG. 11E, the principles of which are still applicable).

Reference numeral 215A in FIG. 2 designates a portion of the outer shell 215 that is configured to be secured to the actuating cable of a cable and pulley arrangement of the closing mechanism, in a manner similar to what has already been described in relation to the known CSO capture system 1 shown e.g. in FIG. 11E (see also [Richard-Noca2016] and [Collaud2017]). In that regard, it should be understood that the closing mechanism could in particular be designed in substantially the same way as the closing mechanism 300 of the known CSO capture system as depicted e.g. in FIG. 11E, namely with a common closing drive unit 305 controlling pivotal movement of all of the deployment units 210 about their respective pivot axis A, preferably via a cable and pulley arrangement 306/307. Other solutions could however be contemplated to cause pivotal movement of the outer shell 215 and associated boom guide support 216.

FIG. 2A is a photographic illustration of the bi-stable reelable composite (BRC) boom used as deployable boom 250. As this is apparent from this photographic illustration, the boom 250 can be rolled onto itself in a first, stable reeled configuration and unrolled into a second, stable configuration in which it takes a substantially cylindrical shape. The structure of the bi-stable reelable composite (BRC) boom will not be discussed in detail here as direct reference can be made to [Richard-Noca2016] and [Collaud2017] in that regard, the information contained therein being of direct relevance.

FIG. 2B is a schematic functional diagram of the relevant components of the deployment unit 210 of FIG. 2, namely of the spool 211, the driving shaft 212 thereof, the outer shell 215 and the mounting supports 217. The boom guide support 216 is not specifically illustrated in FIG. 2B but understood to be secured to the outer shell 215 for pivotal movement therewith. The BRC boom 250 is not shown either in FIG. 2B but understood to be rolled onto the spool 211.

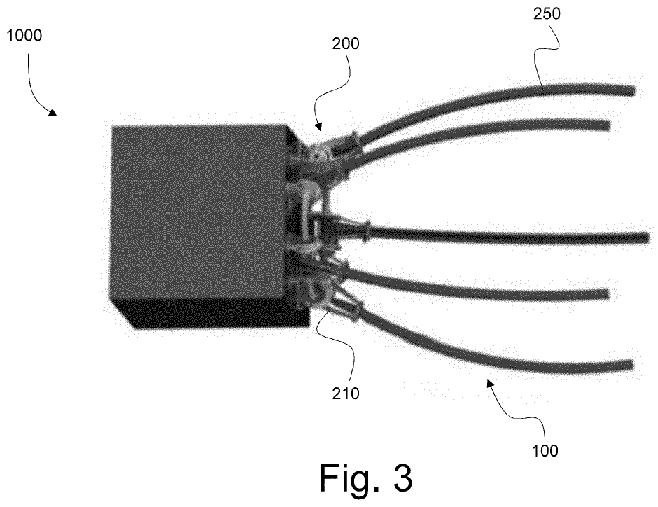

FIG. 3 is a schematic illustration of an orbital chaser 1000 comprising a capture system 100 according to the invention, the capture structure of which is not illustrated for the sake of simplification. In FIG. 3, the deployment platform 200 is shown as comprising five deployment units 210 and associated booms 250 (here shown in a partly deployed configuration), but the actual number of deployment units 210 (which preferably ranges from three to five) may vary depending on the needs.

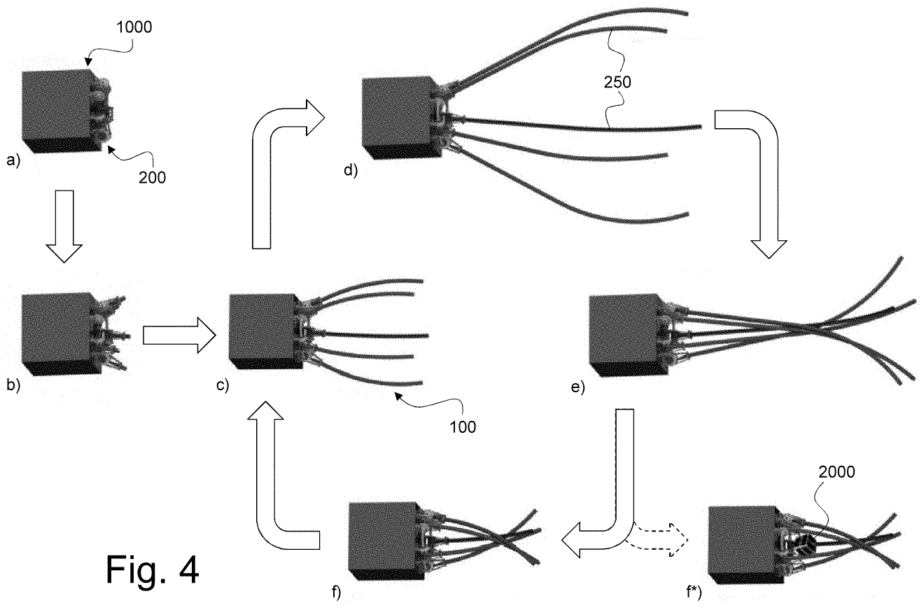

FIG. 4 is a schematic illustration of a preferred deployment scenario of the orbital chaser 1000 and associated capture system 100 during capture of a selected orbital object, here shown as the SwissCube-1 and designated by reference numeral 2000. The capture structure 110 and foldable sheet-like structures 115 thereof are once again not depicted in FIG. 4 for the sake of simplification.

According to the preferred deployment scenario shown in FIG. 4, the orbital chaser 1000 is launched into orbit with the capture system 100 being configured to initially take a stowed launch position a) (see also FIGS. 10A-C). Once the orbital chaser 1000 has reached its desired orbit, the capture system 100 is subsequently switched to the standby position b) (see also FIGS. 10D-F). Advantageously, switching from the stowed launch configuration a) to the standby configuration b) is carried out by operating the closing mechanism to cause pivotal movement of the deployment units 210 about their respective pivot axis A, and thereby bring the capture structure 110, i.e. each foldable sheet-like structure 115, from a corresponding stowed configuration to its standby configuration (e.g. from the configuration shown in FIG. 10A to the configuration shown in FIG. 10D).

The standby configuration b) of the orbital chaser 1000 is the typical configuration in which the orbital chaser 1000 will be put prior to a capture attempt. The orbital chaser 1000 will preferably stay in this standby configuration b) as long as no capture attempt is carried out. Once the selected orbital object to be captured is located and the orbital chaser 1000 has been manoeuvred to perform a rendezvous with the selected orbital object, the capture system 100 will be operated to bring the capture structure 110 to a fully deployed open configuration d). In FIG. 4, this is preferably carried out, prior to a first capture attempt, by operating the deployment platform 200 to bring the deployable booms 250 and the associated capture structure 110 from the standby configuration b) to a partly deployed open configuration c) and then from this partly deployed open configuration c) to the fully deployed open configuration d).

Once the capture structure 110 has been fully deployed, the orbital chaser 1000 can be manoeuvred to bring the selected orbital object inside the capture volume of the capture structure 110, and the capture system 100 can then be operated to close the capture structure 110, namely by operating the closing mechanism to bring the deployed booms 250 and associated capture structure 110 from the fully deployed open configuration d) to a fully deployed closed configuration e).

The capture system 100 can then be operated to retract the deployable booms 250 and associated capture structure 110. More precisely, the deployment platform 200 is preferably operated to bring the booms 250 and capture structure 110 from the fully deployed closed configuration e) to a partly retracted closed configuration, upon which it is checked if successful capture of the orbital object 2000 was performed.

At this stage, two outcomes are basically possible:
(i) the selected orbital object 2000 has been successfully captured, as depicted by f*) in FIG. 4; or
(ii) the capture attempt was unsuccessful, as depicted by f) in FIG. 4, and a further capture attempt needs to be carried out.

In case of a capture failure, the capture system 100 is operated to open the capture structure 110, upon which the capture process is repeated. This is preferably carried out by operating the closing mechanism to bring the booms 250 and the associated capture structure 110 from the partly retracted closed configuration f) back to the partly deployed open configuration c), after which the process can be repeated again.

In case of a successful capture, a deorbiting operation can subsequently be carried out. By way of preference, the capture system 100 may be operated again to firmly lock the captured object 2000 and ensure that it cannot move any further inside the closed capture system 100. Appropriate measures could in particular be taken to definitively lock the capture system 100 in place and prevent any risk that the captured object 2000 can escape or otherwise move and thereby change the centre of mass or inertia of the chaser-object couple, which could otherwise interfere with the deorbiting operations.

The deorbiting operations could in essence be carried out in a more or less controlled manner, namely by manoeuvring the orbital chaser to bring it to a control descent or to bring it to a lower orbit to interact with the upper Earth atmosphere, thereby leading to its re-entry and disintegration. Specific additional measures could however be taken to permit a non-destructive atmospheric re-entry of the captured object, should it be desirable to e.g. be in position to investigate the possible cause of a failure of the orbital object that led to the necessity of its decommissioning. In that respect, the disclosure of U.S. Pat. Nos. 5,511,748 A and 5,421,540 A, which are hereby incorporated by reference in their entirety, are of relevance with respect to the implementation of destructive or non-destructive deorbiting scenarios.

Turning now to FIGS. 5A-C, the underlying principles for a preferred embodiment of the fold pattern of each foldable sheet-like structure 115 according to the invention will be described. These underlying principles are strongly inspired by Origami principles, the well-known art of paper folding, as described below.

The general design of the fold pattern adopted in the context of a preferred embodiment of the invention is essentially based on a tessellation of sections formed by a combination of mountain folds (i.e. folds designed to form convex structures from two contiguous sections) and valley folds (i.e. folds designed to form concave structures from two contiguous sections) extending over the surface of the relevant sheet-like structure. Evidently, these notions (mountain folds vs. valley folds) are dependent on the relevant referential and are interchangeable, i.e. a mountain fold as seen from one side of the relevant sheet-like structure corresponds to a valley fold as seen from the opposite side of the relevant sheet-like structure.

FIG. 5A is a schematic illustration of a foldable sheet-like structure SS and associated fold pattern consisting of a combination of mountain folds ME (shown as thick uninterrupted line sections) and valley folds VF (shown as thick dashed line sections) that subdivide the relevant surface of the sheet-like structure SS into a tessellation of contiguous trapezoidal sections T₁, T₂, T₃, T₄, etc. More precisely, the fold pattern is selected to define a succession of foldable structural bands designated by reference signs BND₁ to BND₄ in FIG. 5A, which bands BND₁ to BND₄ extend transversely to a direction D, hereinafter referred to as the direction of deployment (or folding direction) of the foldable sheet-like structure SS. Only four foldable structural bands BND₁ to BND₄ are shown in FIG. 5A for the purpose of illustration, but the principle is applicable to any number of bands.

The foldable structural bands BND₁ to BND₄ are defined by transverse folds (i.e. folds extending transversely to the direction of deployment D) consisting of an alternation of mountain folds MF and valley folds VF as depicted in FIG. 5A. The transverse folds accordingly extend along, and define borders between the foldable structural bands BND₁ to BND₄, transversely to the direction of deployment D.

Furthermore, each foldable structural band BND₁ to BND₄ is subdivided into an alternation of trapezoidal band sections T₁, T₂, T₃, T₄, etc., by the provision of cross folds (i.e. folds extending across each foldable structural band along directions that are neither transverse to nor parallel with the direction of deployment D), namely mountain and valley folds MF, VF that are angled with respect to the transverse folds. The cross folds accordingly extend across each foldable structural band BND₁ to BND₄ to form acute and obtuse trapezoids T₁, T₂, T₃, T₄, etc. in the illustrated example. In FIG. 5A, angles β₁ and β₂ designate the angles formed between contiguous mountain folds MF along e.g. the fourth band BND₄, while angle β₃ designates the angle formed between contiguous valley folds VF along the fourth band BND₄.

As depicted in FIG. 5A, the mountain and valley folds MF, VF join at defined vertices located along borders of the foldable structural bands BND₁ to BND₄ (including borders of the sheet-like structure SS). In FIG. 5A, for the sake of distinction, reference sign VRTX_{I} designates an internal vertex formed within the boundary of the foldable sheet-like structure SS and is shown as a white dot, while reference sign VRTX_{B} designates a boundary vertex formed along the borders of the sheet-like structure SS and is shown as a dashed dot.

By way of preference, as shown in FIG. 5A, the succession of foldable structural band BND₁ to BND₄ includes an alternation of first and second foldable structural bands, namely “odd” bands BND₁ and BND₃ and “even” bands BND₂ and BND₄. The “odd” bands BND₁, BND₃ are identical, i.e. exhibit the same distribution of mountain and valley folds MF, VF. Similarly, the “even” bands BND₁, BND₃ are identical, but exhibit a distribution of mountain and valley folds MF, VF that is the mirrored image of that of the “odd” bands BND₁, BND₃, i.e. the folds are mirrored with respect to the horizontal axis (i.e. the axis extending transversely to the direction of deployment D).

The arrangement of the mountain and valley folds MF, VF shown in FIG. 5A is selected to ensure that the sheet-like structure SS can be flat folded, as schematically shown in FIG. 5B. This is achieved by satisfying certain design rules regarding the fold pattern.

A first design rule (also referred to as “Maekawa's Theorem”) imposes that the absolute difference between the number N_{MF} of mountain folds MF and the number N_{VF} of valley folds VF around an internal vertex VRTX_{I} must be equal to 2:

$$\vert {N}_{MF} - {N}_{VF} \vert = 2 \qquad ( 1 )$$

A second design rule (also referred to as “Kawasaki's Theorem”), which must be satisfied in order for the sheet-like structure SS to be flat foldable, imposes that the alternating sum of angles between the folds around an internal vertex VRTX_{I} must be equal to zero:

$${\sum }_{i = 1}^{{N}_{a}} {( - 1 )}^{i - 1} {α}_{i} = 0 \qquad ( 2 )$$

where Nₐ is the number of angles around the relevant internal vertex VRTX_{I} and αᵢ are the relevant angles around the internal vertex VRTX_{I}.

Angles α₁ to α₄ are shown in FIG. 5A around a selected internal vertex VRTX_{I} located on the border between bands BND₁ and BND₂ for the purpose of illustration of this second design rule. In this illustrative example, the number of angles Nₐ is four and the alternating sum of the four angles, namely (α₁−α₂)+(α₃−α₄), is indeed zero by virtue of the mirrored arrangement of the relevant folds.

As long as both of the above design rules (1) and (2) are respected, and by playing with the relevant angles between the folds and with the distribution of the folds along each structural band, the sheet-like structure SS can be flat folded as depicted by way of illustration in FIG. 5B.

The resulting shape of the flat-folded sheet-like structure SS is directly dependent on the selected arrangement of the folds. In particular, the angles between the folds and the relevant lengths of the band sections resulting from the distribution of the folds will be determinant. For the sake of illustration, the lengths l₁ to l₄ of the relevant transverse folds between bands BND₂ and BND₃ is indicated in FIG. 5A and also reflected in FIG. 5B, in addition to angles β₁ to β₃.

FIG. 5C is a schematic perspective view of the foldable sheet-like structure SS of FIG. 5A in a partly folded/unfolded configuration, which perspective view highlights the resulting alternation of convex and concave sections.

The aforementioned principles are put into practice, in accordance with a particularly preferred embodiment of the invention, to create the relevant fold pattern for each of the foldable sheet-like structures 115 of the capture system 100 of the invention.

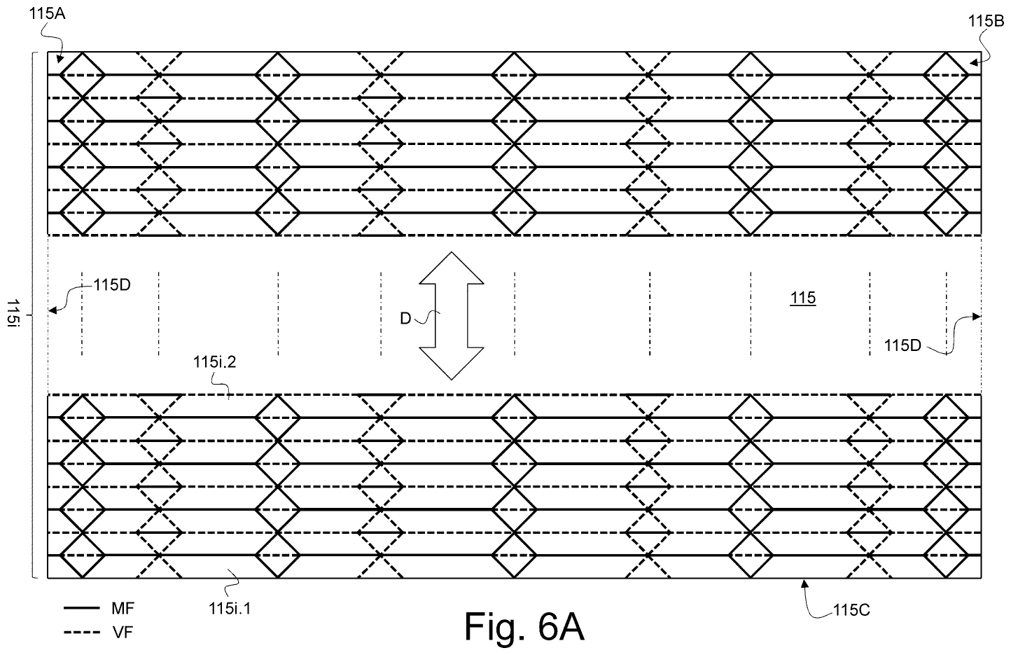

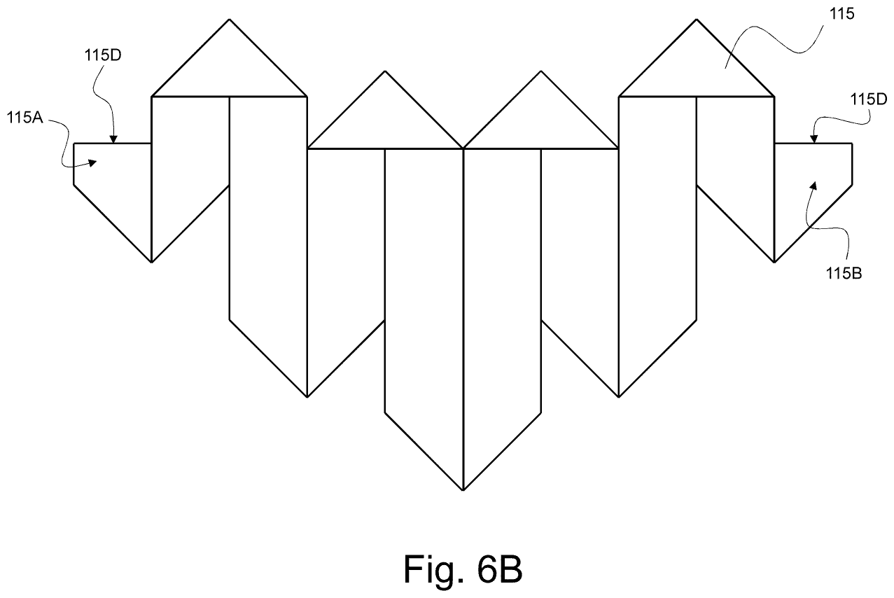

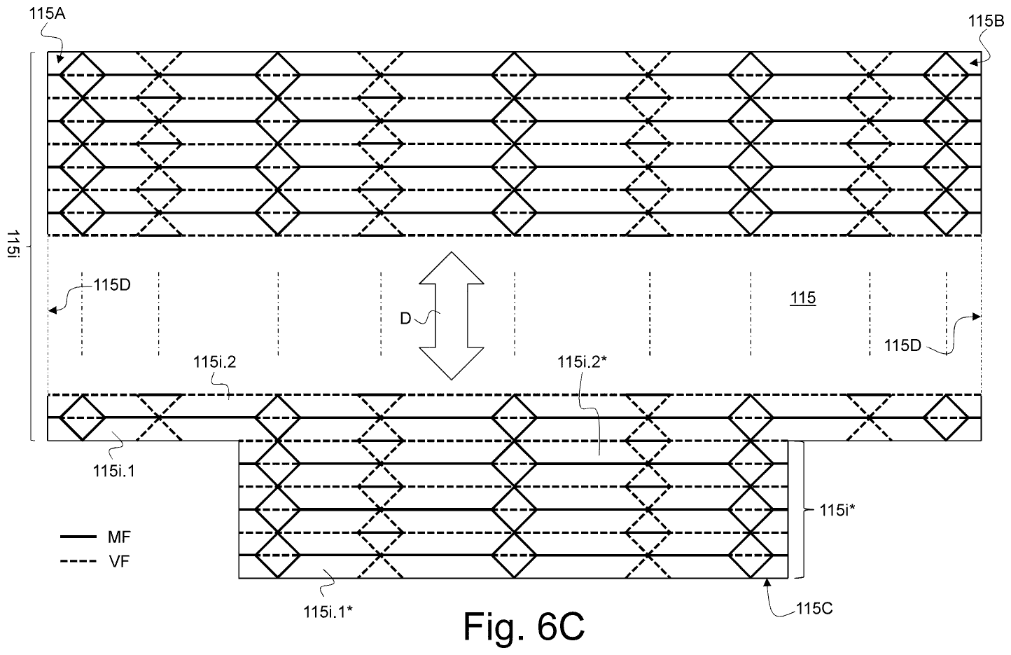

An illustrative example of a possible fold pattern designed along the aforementioned principles is shown in FIG. 6A. The relevant fold pattern shown in FIG. 6A is likewise selected to define a succession of foldable structural bands 115i extending transversely to the direction of deployment D of the foldable sheet-like structure 115, each of the foldable structural bands 115i exhibiting a plurality of mountain folds MF and a plurality of valley folds VF joining at defined vertices located along borders of the foldable structural bands 115i, which mountain folds MF and valley folds VF extend across each of the foldable structural bands 115i and along the border between the foldable structural bands 115i to form essentially triangular or trapezoidal band sections. In that regard, the triangular band sections can be assimilated to an extreme case of acute trapezoidal sections in which the shorter one of the two parallel segments of the trapezoids is reduced to zero.

In a manner similar to the fold pattern shown in FIG. 5A, the succession of foldable structural bands 115i shown in FIG. 6A includes an alternation of first (“odd”) and second (“even”) foldable structural bands 115i.1, 115i.2, respectively, wherein each of the first foldable structural bands 115i.1 is a mirrored image of each of the second foldable structural bands 115i.2.

The resulting configuration of the foldable sheet-like structure 115 of FIG. 6A, upon being flat folded, is shown in FIG. 6B. One may note that the cross folds are selected in the illustrated example to extend substantially at +45 degrees or −45 degrees with respect to the direction of deployment D, leading to a juxtaposition of substantially parallel band sections in the flat-folded configuration.

For the sake of explanation, reference signs 115A and 115B in FIGS. 6A and 6B designate first and second upper end portions of the foldable sheet-like structure 115. These upper end portions 115A, 115B will be exploited for attachment to a distal end of the associated booms 250 used to deploy the structure 115. Conversely, reference sign 115C designates a lower end portion of the foldable sheet-like structure 115 that will be secured to a base of the deployment platform 200. Lastly, reference sign 115D designates lateral ends of the foldable sheet-like structure 115 that will be slidably secured to the associated booms 250 as detailed hereafter.

Another illustrative example of a possible fold pattern designed along the aforementioned principles is shown in FIG. 6C. In contrast to the example of FIG. 6A, the sheet-like structure 115 exhibits, in the unfolded state, a lower section having a smaller transverse width (or “nominal unfolded width”) than an upper section of the sheet-like structure 115. Both sections likewise exhibit a succession of foldable structural bands 115i* (115i.1*, 115i.2*), respectively 115i (115i.1, 115i.2) satisfying the same design rules mentioned above. In effect, the fold pattern shown in FIG. 6C is basically identical to that shown in FIG. 6A, with the only difference residing in the shape of the border of the sheet-like structure 115. This shape will not as such impact the ability of the sheet-like structure 115 to be flat-folded, the resulting configuration of the sheet-like structure 115 of FIG. 6C upon being flat folded remaining similar to what is shown in FIG. 6B.

The advantage of the foldable sheet-like structure 115 shown in FIG. 6C over that shown in FIG. 6A resides in that the amount of material at the lower end portion 115C of the sheet-like structure 115 is reduced, thereby necessitating less accommodating space at the base of the deployment platform 200 where the sheet-like structure 115 is secured.

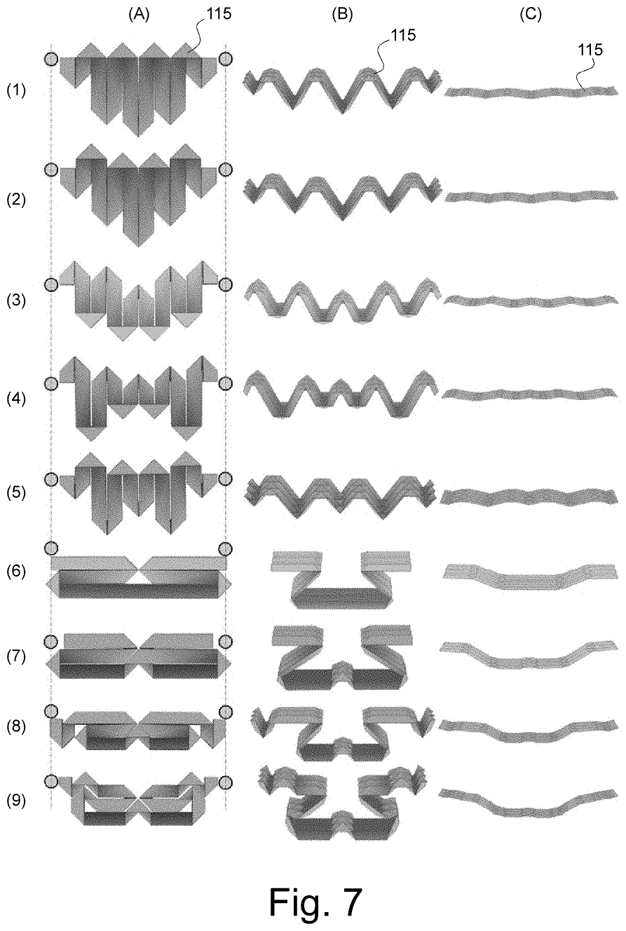

Evidently, one has great flexibility in how to implement the desired fold pattern. FIG. 7 is illustrative of nine different examples (1) to (9) of foldable sheet-like structures 115 in accordance with embodiments of the invention. The second example (2) shown in FIG. 7 in essence corresponds to the example discussed above with reference to FIGS. 6A-C. In FIG. 7, the left column (A) illustrates the relevant foldable sheet-like structures 115 upon being flat folded, the middle column (B), the relevant structures 115 upon being partly unfolded, and the right column (C), the relevant structures 115 upon being almost completely unfolded.

FIG. 7 in particular illustrates that different configurations and curvatures can be imparted to the foldable sheet-like structure 115 depending on the selected fold pattern. In particular, the foldable sheet-like structure 115 can be configured in such a way as to be generally curved outwardly when in the fully deployed configuration of the capture structure 110.

FIGS. 8A-B are photographic illustrations of a prototype of a foldable sheet-like structure 115 as mounted between first and second deployed BRC booms 250.1, 250.2 of corresponding first and second deployment units 210.1, 210.2 of the deployment platform 200. For the sake of illustration, the foldable sheet-like structure 115 shown in FIGS. 8A-B corresponds substantially to the example (2) of FIG. 7.

FIG. 8A shows the foldable sheet-like structure 115 in a fully deployed open configuration, as seen from the interior of the capture volume (only one foldable sheet-like structure 115 being shown). The first and second upper end portions 115A, 115B of the sheet-like structure 115 are attached to a distal end of the associated booms 250.1, 250.2, respectively, while the first and second lateral ends 115D of the foldable sheet-like structure 115 are slidably secured to each of the booms 250.1, 250.2. This is preferably done by means of plurality of eyelets 260 provided on the lateral ends 115D and distributed along a length thereof, which plurality of eyelets 260 is adapted to slide along the first, respectively second deployable boom 250.1, resp. 250.2, upon being deployed.

FIG. 8B shows the foldable sheet-like structure 115 in a fully deployed closed configuration, as seen from the exterior of the capture volume. This illustrates that the foldable sheet-like structure 115 follows closure of the booms 250.1, 250.2 (upon being closed by the closing mechanism) to adequately close the capture volume.

By way of preference, as shown in the schematic illustration of FIG. 1A, each deployable boom 250 is configured to exhibit, upon being fully deployed, a first section 250A that is substantially rectilinear followed by a second section 250B that is curved inwardly. In that regard, a distribution of the plurality of eyelets 260 along the length of the first and second lateral ends 115D of each foldable sheet-like structure 115 is preferably such that a higher density of eyelets 260 is provided at a portion of the first and second lateral ends 115D that coincides with the inwardly curved end portion 250B of each deployable boom 250. This measure ensures that the foldable sheet-like structure 115 will adequately follow closure of the deployed booms 250 with a view to ensure proper closure of the capture structure 110.

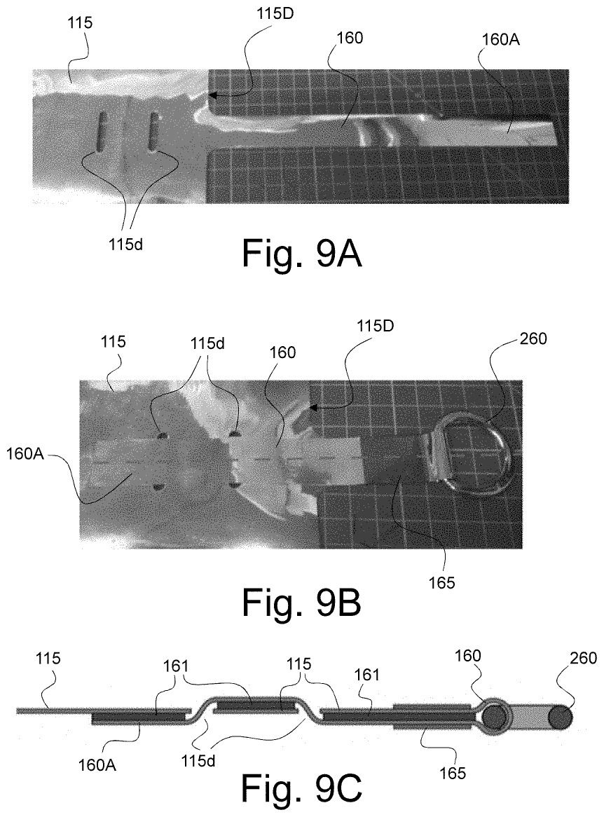

FIGS. 9A-C are illustrative of a preferred solution for providing and securing the eyelets 260 along the first and second lateral ends 115D of the sheet-like structure 115.

As shown in FIG. 9A, attachment strips 160 are preferably provided along the length of the lateral ends 115D, which attachment strips 160 extend away from the first, respectively second lateral end 115D of the sheet-like structure 115. The direction of extension of the attachment strips 160 is in effect substantially perpendicular to the direction of deployment D. The attachment strips 160 ideally form an integral part of the foldable sheet-like structure 115, which ensures optimum reliability for the attachment of the eyelets 260.

As further shown in FIG. 9A, two elongated apertures 115d (more than two such apertures 115d could actually be provided) are formed on the foldable sheet-like structure 115 next to each attachment strip 160. These apertures 115d are preferably provided in order to properly secure the attachment strip 160 to the associated eyelet 260, as shown in FIGS. 9B-C.

As shown in FIGS. 9B-C, an eyelet 260 is secured to the attachment strip 160 by passing an end portion 160A of the attachment strip 160 through the associated eyelet 260 and by weaving the end portion 160A successively through the aforementioned elongated apertures 115d. The end portion 160A is then secured by adequate measures to the adjacent portions of the sheet-like structure 115. Reference numeral 161 in FIG. 9C for instance designates adhesive material (such as double-sided tape) that is interposed between the end portion 160A and the surface of the foldable sheet-like structure 115. Reference numeral 165 in FIGS. 9B-C, on the other hand, designates a securing band (such as Kapton adhesive tape) surrounding the attachment strip 160 next to the eyelet 260.

In accordance with a preferred embodiment of the invention, each foldable sheet-like structure 115 is made of a sheet or foil of flexible material. Different flexible materials could be contemplated, but polyimide (PI) material, such as Kapton, or polyethylene terephthalate (PET) material, in particular biaxially-oriented polyethylene terephthalate (BoPET) material, such as Mylar, are particularly suitable. Mylar (or like BoPET materials) is an especially interesting candidate.

Considering that the particular mission may require the orbital chaser and associated capture system to remain in orbit for a certain time, it is furthermore advantageous to coat each foldable sheet-like structure 115 for protection against corrosion by atomic oxygen (ATOX). In that regard, aluminium coatings may in particular come into consideration.

As regards the thickness of each foldable sheet-like structure, it is preferable to ensure that such thickness be ideally comprised between 100 μm and 150 μm, which ensures both a sufficient flexibility for the folding operation and an adequate robustness and resistance against tear.

FIGS. 10A-F are renderings of a capture system, likewise generally designated by reference numeral 100, in accordance with another embodiment of the invention. The capture system 100 shown in FIGS. 10A-F likewise comprises a deployment platform 200 including a total of three deployment units 210, namely first to third deployment units 210.1, 210.2, 210.3, each being designed to allow deployment of an associated deployable boom 250, namely first to third deployable booms 250.1, 250.2, 250.3, respectively.

Each deployment unit 210.1, 210.2, 210.3 is of a similar construction as the deployment unit 210 shown in FIG. 2 and the same reference numerals 211, 212, 215, 215A, 216, 217 are used in FIGS. 10A-F to designate the same functional components of each deployment unit 210.1, 210.2, 210.3, without it being accordingly necessary to describe these functional components again. Reference numeral 206 in FIGS. 10A-F likewise designates a pair of flexible axes interconnecting in sequence the deployment units 210.1, 210.2, 210.3 for the purpose of ensuring the driving connection between all spools 211 and thereby the common deployment (or retraction) of the associated deployable booms 250.1, 250.2, 250.3.

The capture structure 110 likewise comprises, as illustrated in FIGS. 10A-F, a plurality of, namely three, foldable sheet-like structures 115.1, 115.2, 115.3 that are each coupled between an associated pair of said deployable booms 250.1/250.2, 250.2/250.3, 250.3/250.1, respectively. The foldable sheet-like structures 115.1, 115.2, 115.3 are shown in FIGS. 10A-F in a folded, undeployed configuration. As this is especially visible in FIGS. 10D and 10E, the foldable sheet-like structures 115.1, 115.2, 115.3 essentially correspond to a design that is substantially identical to example (4) of FIG. 7, which is optimized for foldability in the stowed configuration.

FIGS. 10A-C illustrate the capture system 100 in a stowed launch configuration, with the deployment units 210.1, 210.2, 210.3 being each pivoted into a corresponding position (as shown individually in FIG. 10C) wherein the deployments units are oriented towards the centre of the deployment platform 200 and wherein each of the foldable sheet-like structures 115.1, 115.2, 115.3 takes a corresponding stowed configuration. In this stowed configuration, each foldable sheet-like structure 115.1, 115.2, 115.3 is specifically positioned and partly bent and curved to take a more compact configuration than in the standby configuration.

FIGS. 10D-F illustrate the capture system 100 in a standby configuration, with the deployment units 210.1, 210.2, 210.3 being each pivoted outwardly, from the stowed launch position, into a corresponding standby position. As this is clearly visible in FIG. 10D, the standby configuration is an open configuration in which the individual foldable sheet-like structures 115.1, 115.2, 115.3 do not obstruct the field of view of the sensor system 500 that is located in a central portion of the deployment platform 200.

In a manner similar to the other previously described embodiments, switching of the capture system 100 from the stowed launch position to the standby position is carried out by pivotal movement of each deployment unit 210.1, 210.2, 210.3 about their respective pivot axis, which pivot axis again coincides with the axis of rotation of the spools 211. While the relevant closing mechanism is not specifically shown in FIGS. 10A-F, it shall be understood that pivotal movement of the deployment units 210.1, 210.2, 210.3 may likewise be controlled by operation of a closing mechanism similar to the closing mechanism 300 as already described in connection with the known CSO capture system (see again FIG. 11E).

Further adaptations and improvements of the capture system 100 have been implemented in the embodiment shown in FIGS. 10A-F.

A first adaptation resides in the provision of a retaining mechanism configured to hold the sheet-like structures 115.1-115.3 in the stowed configuration. In the illustrated example, the retaining mechanism advantageously comprises pairs of retaining members 220A, 220B and finger members 225A, 225B provided on each deployment unit 210.1-210.3 as described below.

As shown in FIG. 10C, the pair of retaining members 220A, 220B is secured to the outer shell 215 of the deployment unit 210 for pivotal movement therewith. More precisely, a first retaining member 220A is located on one side of the deployment unit 210 to cooperate with and hold a selected portion of each foldable sheet-like structure 115.1, 115.2, 115.3 (as shown in FIGS. 10A and 10B), and a second retaining member 220B is located on the other side of the deployment unit 210 to likewise cooperate with and hold another selected portion of each foldable sheet-like structure 115.1, 115.2, 115.3 (as again shown in FIGS. 10A and 10B). In the illustrated example, the first and second retaining members 220A, 220B are specifically designed to hold the sheet-like structures 115.1, 115.2, 115.3 in the stowed configuration by cooperating with the two larger extensions present near the sides of the flat-folded sheet-like structures 115.1, 115.2, 115.3. In the stowed configuration, as illustrated by FIGS. 10A and 10B, the relevant sections are bent approximately at 90 degrees to the side with respect to the central portion of the sheet-like structures 115.1, 115.2, 115.3 which is curved into a U-shaped configuration. Upon switching from the stowed configuration to the standby configuration, the retaining members 220A, 220B pivot together with the outer shell 215 of the deployment units 210.1-210.3 and automatically release the selected portions of the sheet-like structures 115.1, 115.2, 115.3.

As further shown in FIG. 10C, the pair of finger members 225A, 225B is likewise secured to the outer shell 215 of the deployment unit 210 for pivotal movement therewith. Each finger member 225A, 225B is configured to maintain a selected portion of the foldable sheet-like structures 115.1, 115.2, 115.3 in the stowed configuration. More precisely, a first finger member 225A is located on one side of the deployment unit 210 to cooperate with and maintain the selected portion of each foldable sheet-like structure 115.1, 115.2, 115.3 from a first side (as shown in FIG. 10B), and a second finger member 225B is located on the other side of the deployment unit 210 to likewise cooperate with and maintain the selected portion of each foldable sheet-like structure 115.1, 115.2, 115.3 from the other side (as again shown in FIG. 10B). In the illustrated example, as shown in FIG. 10B, a distal end of each finger member 225A, 225B cooperates with the central portion of the sheet-like structures 115.1, 115.2, 115.3 which is curved into the U-shaped configuration, thus maintaining the sheet-like structures 115.1, 115.2, 115.3 in the stowed configuration. Furthermore, in the illustrated example, the finger members 225A, 225B extend, in the stowed configuration, below the selected portions of the sheet-like structures 115.1, 115.2, 115.3 which are held by the retaining members 220A, 220B.

In the illustrated example, the first and second finger members 225A, 225B are further configured to assist switching of the foldable sheet-like structures 115.1-115.3 from the stowed configuration to the standby configuration. Indeed, upon switching from the stowed configuration to the standby configuration, the finger members 225A, 225B pivot together with the outer shell 215 of the deployment units 210.1-210.3, thereby freeing the central portion of the foldable sheet-like structures 115.1-115.3 as well as ensuring proper release of the portions thereof out of the retaining members 220A, 220B. The finger members 225A, 225B accordingly ensure a reliable release and switching of the foldable sheet-like structures 115.1-115.3 from the stowed configuration to the standby configuration.

The provision of the aforementioned retaining mechanism is particularly useful in ensuring that the capture system 100 can be maintained in a compact stowed position for launch purposes.

A second adaptation resides in the provision of a holding member 230 at the distal end of each deployable boom 250, which holding member 230 comprises first and second arms 230A, 230B (see FIGS. 10C and 10F) that are configured to hold an associated pair of foldable sheet-like structures 115.1/115.3, 115.2/115.1, 115.3/115.2 in the standby configuration. These holding members 230 are visible in FIGS. 10A-F, provided on the distal end of the booms 250.1, 250.2, 250.3. Each holding member 230 is attached to the distal end of the relevant boom 250.1, 250.2, 250.3, respectively, by means of a central attachment point 230C (see FIG. 100). As shown in FIGS. 10D-F, the first arm 230A of the holding member 230 is configured to hold a first upper portion of a first foldable sheet-like structure 115.1, 115.2, 115.3, respectively, in the standby configuration, while the second arm 230B of the holding member 230 is configured to hold a second upper portion of a second foldable sheet-like structure 115.3, 115.2, 115.1, respectively, in the standby configuration. The holding members 230 ensure that the foldable sheet-like structures 115.1, 115.2, 115.3 are appropriately held in the standby configuration and do not obstruct the field of view of the sensor system 500.

A third adaptation resides in the provision of a support element 235 secured to the lower end portion 115C of each foldable sheet-like structure 115.1, 115.2, 115.3 to ensure support and attachment thereof to the base of the deployment platform 200. These support elements 235 can especially take the form of flexible support bands, made e.g. of Kapton adhesive tape, secured to the lower end portion 115C of each foldable sheet-like structure 115.1, 115.2, 115.3, which flexible support bands are secured at both ends to a corresponding portion of the deployment units 210.1, 210.2, 210.3, namely to a portion of the outer shell 215 thereof. As may be seen in FIG. 10B, the support element 235 are preferably provided on the underside of the sheet-like structures 115.1, 115.2, 115.3 in such a way as to cooperate with the distal end of the finger elements 225A, 225B and form a bearing shoulder ensuring reliable retention of the sheet-like structures 115.1, 115.2, 115.3 in the stowed configuration.

Various modifications and/or improvements may be made to the above-described embodiments without departing from the scope of the invention as defined by the appended claims. For instance, it should be appreciated that the capture structure of the capture system of the invention may comprise any number of foldable sheet-like structures.

Furthermore, although the embodiments disclosed herein show a capture system adapted to the capture of the SwissCube-1, the capture system could be adapted to the capture of any other orbital object.

In addition, the relevant fold pattern defining the alternation of convex and concave sections that are adapted to automatically fold one on top of the other upon retracting the capture structure of the invention may differ from the actual embodiments disclosed herein and other configurations of fold patterns could be contemplated without departing from the scope of the present invention as defined by the appended claims. As a matter of fact, the Origami principles discussed herein (especially Maekawa's and Kawasaki's Theorems) could be applied to create other types of fold patterns while still satisfying the basic principles discussed hereabove.

It should likewise be appreciated that the actual shape of the capture envelope as disclosed herein could vary and for instance be mostly cylindrical in the fully deployed open configuration.

Moreover, the actual structure or configuration of the deployment platform and of the closing mechanism could differ from the embodiments disclosed herein and any suitable deployment platform and closing mechanism could be contemplated as long as they adequately permit reversible deployment of the capture structure and reversible closure of the capture structure. In that respect, the use of BRC booms is particularly preferred but not essential. The same applies to the attachment of the plurality of foldable sheet-like structures to the various components of the deployment platform, which attachment could be performed in other ways than specifically disclosed herein.

### LIST OF REFERENCE NUMERALS AND SIGNS USED THEREIN

1 CSO capture system (prior art—FIGS. 11A-F)
10 “Pac-Man” net of CSO capture system 1
11 lower stiffening structure for “Pac-Man” net 10
12 upper stiffening structure for “Pac-Man” net 10
15 protective net
100 CSO capture system (embodiments of invention)
110 deployable capture structure
110A opening of deployed capture structure 110 (open configuration)
115 foldable sheet-like structures jointly forming capture structure 110
115A (first) upper end portion of foldable sheet-like structure 115 for attachment to distal end of (first) boom 250
115B (second) upper end portion of foldable sheet-like structure 115 for attachment to distal end of (second) boom 250
115C lower end portion of foldable sheet-like structure 115
115D lateral ends of foldable sheet-like structure 115
115d elongated apertures on foldable sheet-like structure 115 for passage of attachment strip 160
115i foldable structural bands of foldable sheet-like structure 115
115i.1 first foldable structural bands forming part of foldable structural bands
115i
115i.2 second foldable structural bands forming part of foldable structural bands
115i (mirrored image of foldable structural bands 115i.1)
115i* foldable structural band(s) of foldable sheet-like structure 115 at lower end portion 115C of foldable sheet-like structure 115 (embodiment of FIG. 6C)
115i.1* first foldable structural bands forming part of foldable structural bands
115i*
115i.2* second foldable structural bands forming part of foldable structural bands
115i* (mirrored image of foldable structural bands 115i.1*)
115.1 (first) foldable sheet-like structure
115.2 (second) foldable sheet-like structure
115.3 (third) foldable sheet-like structure
160 attachment strips for eyelets 260 forming an integral part of foldable sheet-like structure 115
160A end portion of attachment strip 160 designed to be woven through apertures 115d
161 adhesive material for securing end portion 160A of attachment strip 160 to surface of foldable sheet-like structure 115 (e.g. double-sided tape)
165 securing band surrounding attachment strip 160 next to eyelet 260 (e.g. Kapton adhesive tape)
200 deployment platform
205 (first) actuating drive controlling deployment of deployable booms 250 (common deployment drive unit, e.g. motor)
206 flexible axes interconnecting driving shafts 212 of spools 211 of deployment units 210
210 deployment unit(s)/DU(s)
210.1 (first) deployment unit
210.2 (second) deployment unit
210.3 (third) deployment unit
210.4 (fourth) deployment unit
210.5 (fifth) deployment unit
211 spool of deployment unit 210 for rolling, respectively unrolling of bi-stable reelable composite (BRC) boom 250/rotatable about axis A
212 driving shaft of spool 211
215 outer shell of deployment unit 210/pivotable about axis A independently of rotation of spool 211
215A portion of outer shell 215 secured to actuating cable 306 of closing mechanism 300
216 boom guide support secured to outer shell 215/pivotable about axis A together with outer shell 215
217 mounting supports for outer shell 215
220A (first) retaining member for holding selected portion of folded sheet-like structure 115, 115.1-115.3 in stowed configuration (FIGS. 10A-C)
220B (second) retaining member for holding selected portion of folded sheet-like structure 115, 115.1-115.3 in stowed configuration (FIGS. 10A-C)
225A (first) finger member for assisting switching of the folded sheet-like structure 115, 115.1-115.3 from the stowed configuration to the standby configuration (FIGS. 10A-F)
225B (second) finger member for assisting switching of the folded sheet-like structure 115, 115.1-115.3 from the stowed configuration to the standby configuration (FIGS. 10A-F)
230 holding member secured to distal end of boom 250, 250.1-250.3 and configured to hold upper portion of foldable sheet-like structures 115,
115.1-115.3 in the standby configuration
230A (first) arm of holding member 230 configured to hold upper portion of a first one of the foldable sheet-like structure 115, 115.1-115.3
230B (second) arm of holding member 230 configured to hold upper portion of a second one of the foldable sheet-like structure 115, 115.1-115.3
230C attachment point of holding member 230 to distal end of boom 250,
250.1-250.3
235 (lower) support element secured to base of deployment platform 200 and to lower end portion 115C of foldable sheet-like structure 115, 115.1-115.3
250 deployable boom(s)/bi-stable reelable composite (BRC) boom(s)
250A rectilinear section of deployed boom 250
250B curved section of deployed boom 250
250.1 (first) deployable boom
250.2 (second) deployable boom
250.3 (third) deployable boom
260 eyelets secured to lateral ends of foldable sheet-like structure 115/slidable along deployable booms 250
300 closing mechanism
305 (second) actuating drive controlling closing/opening of deployable booms
250 and therefore closing/opening of capture structure 110 (common closing drive unit)
306 actuating cable of closing mechanism 300/drivingly connected to outer shells 215 of deployment units 210
307 pulleys guiding actuating cable 306
500 sensor system for tracking and rendezvous operations
1000 spacecraft (or “orbital chaser”)
2000 orbital object to be captured (e.g. SwissCube-1)
A axis of rotation of spool 211/pivot axis of outer shell 215 and boom guide support 216
BND₁₋₄ foldable structural bands
CL centreline of capture structure 110
D direction of deployment of foldable sheet-like structure 115
MF mountain fold(s) on foldable sheet-like structure SS, resp. 115 (part of fold pattern)
SS foldable sheet-like structure (FIGS. 5A-C)
T₁-T₄ trapezoidal band sections formed along foldable structural bands BND₁₋₄ (FIGS. 5A-C)
VF valley fold(s) on foldable sheet-like structure SS, resp. 115 (part of fold pattern)
VRTX_{B} boundary vertex formed along boundary of foldable sheet-like structure SS, resp. 115
VRTX_{I} internal vertex formed within boundary of foldable sheet-like structure SS, resp. 115
l₁-l₄ distances between vertices VRTX_{B} and VRTX_{I} along border between foldable structural bands BND₂ and BND₃
α₁-α₄ angles about internal vertex VRTX_{I} formed between contiguous mountain and valley folds MF, VF
β₁ angle formed between contiguous mountain folds MF (FIGS. 5A-C)
β₂ angle formed between contiguous mountain folds MF (FIGS. 5A-C)
β₃ angle formed between contiguous valley folds VF (FIGS. 5A-C)

1.-45. (canceled)

46. A capture system adapted to capture orbital objects, comprising:
a deployable capture structure designed to be deployable between a standby configuration and a fully deployed open configuration, in which the capture structure defines a capture volume with an opening dimensioned to receive and capture a selected orbital object;
a deployment platform designed to deploy the capture structure; and
a closing mechanism designed to close the capture structure around the selected orbital object located within said capture volume,
wherein the capture structure consists of a capture envelope comprising a plurality of foldable sheet-like structures each configured to be reversibly foldable and unfoldable as a function of deployment of the capture structure, each foldable sheet-like structure being designed to take a first configuration, in which the foldable sheet-like structure is folded on itself to form the standby configuration of the capture structure, and at least a second configuration, in which the foldable sheet-like structure is unfolded and extended to form the fully deployed open configuration of the capture structure,
and wherein each foldable sheet-like structure exhibits a fold pattern defining an alternation of convex and concave sections in the second configuration, which convex and concave sections are adapted to automatically fold one on top of the other upon retracting the capture structure.

47. The capture system according to claim 46, wherein the fold pattern is selected to allow the foldable sheet-like structure to be flat folded.

48. The capture system according to claim 47, wherein the fold pattern is selected to define a succession of foldable structural bands extending transversely to a direction of deployment of the foldable sheet-like structure, each of the foldable structural bands exhibiting a plurality of mountain folds and a plurality of valley folds joining at defined vertices located along borders of said foldable structural bands, which mountain folds and valley folds extend across each of the foldable structural bands and along the borders between the foldable structural bands to form essentially triangular or trapezoidal band sections.

49. The capture system according to claim 48, wherein the succession of foldable structural bands includes an alternation of first and second foldable structural bands, and wherein each of the first foldable structural bands is a mirrored image of each of the second foldable structural bands.

50. The capture system according to claim 48, wherein the plurality of mountain folds and the plurality of valley folds form a plurality of trapezoidal band sections along each of the foldable structural bands, including acute and/or obtuse trapezoids.

51. The capture system according to claim 50, wherein the plurality of mountain folds and the plurality of valley folds form a succession of trapezoidal band sections and triangular band sections.

52. The capture system according to claim 46, wherein each of the foldable sheet-like structure is configured in such a way as to be generally curved outwardly when in the fully deployed open configuration of the capture structure.

53. The capture system according to claim 46, wherein the deployment platform comprises at least three deployment units positioned in a polygonal arrangement, each deployment unit being configured to allow deployment of a deployable boom causing deployment of the capture structure,
and wherein the capture envelope comprises at least three of said foldable sheet-like structures, each foldable sheet-like structure being coupled between an associated pair of said deployable booms to form a peripherally closed capture envelope.

54. The capture system according to claim 53, comprising three to five deployment units and a corresponding number of said foldable sheet-like structures.

55. The capture system according to claim 53, comprising first to third deployments units and first to third foldable sheet-like structures,
wherein the first foldable sheet-like structure is coupled between the deployable boom of the first deployment unit and the deployable boom of the second deployment unit, wherein the second foldable sheet-like structure is coupled between the deployable boom of the second deployment unit and the deployable boom of the third deployment unit,
and wherein the third foldable sheet-like structure is coupled between the deployable boom of the third deployment unit and the deployable boom of the first deployment unit.

56. The capture system according to claim 53, wherein a nominal unfolded width of each foldable sheet-like structure at a lower end portion thereof is smaller than a nominal unfolded width of each foldable sheet-like structure at an upper end portion.

57. The capture system according to claim 53, wherein first and second lateral ends of each foldable sheet-like structure are each provided with a plurality of eyelets distributed along a length thereof, which plurality of eyelets is adapted to slide along the first, respectively second deployable boom.

58. The capture system according to claim 57, wherein an end portion of each deployable boom is curved inwardly and wherein a distribution of the plurality of eyelets along the length of the first and second lateral ends of each foldable sheet-like structure is such that a higher density of eyelets is provided at a portion of the first and second laterals ends coinciding with the inwardly curved end portion of each deployable boom.

59. The capture system according to claim 57, wherein each foldable sheet-like structure comprises attachment strips extending away from said first and second lateral ends and forming an integral part of the foldable sheet-like structure, which attachment strips are secured to said eyelets.

60. The capture system according to claim 59, wherein each attachment strip is secured to an associated one of said eyelets by passing an end portion of the attachment strip through the associated eyelet and by weaving the end portion of the attachment strip through at least two successive apertures formed on the foldable sheet-like structure next to the attachment strip.

61. The capture system according to claim 53, wherein a lower end portion of each foldable sheet-like structure is secured to a support element, which support element is secured to a base of the deployment platform.

62. The capture system according to claim 53, wherein the deployment platform further comprises a common deployment drive unit to control deployment of all of the deployable booms.

63. The capture system according to claim 62, wherein the common deployment drive unit is coupled to a first one of the deployment units and wherein the remaining deployment units are drivingly connected to said first deployment unit in sequence via flexible axes.

64. The capture system according to claim 53, wherein each deployable boom consists of a bi-stable reelable composite (BRC) boom adapted to be selectively rolled on or unrolled from a spool.

65. The capture system according to claim 53, wherein the closing mechanism is configured to pivot each deployment unit about a pivot axis.

66. The capture system according to claim 64, wherein the closing mechanism is configured to pivot each deployment unit about a pivot axis, which pivot axis coincides with an axis of rotation of the spool.

67. The capture system according to claim 65, wherein the closing mechanism comprises a common closing drive unit to control pivotal movement of all of the deployment units about their respective pivot axis.

68. The capture system according to claim 67, wherein the common closing drive unit controls pivotal movement of the deployment units via a cable and pulley arrangement.

69. The capture system according to claim 46, wherein the capture system is configured to initially take a stowed launch position, in which each foldable sheet-like structure takes a corresponding stowed configuration, and to be subsequently switched to a standby position, in which each foldable sheet-like structure takes the standby configuration.

70. The capture system according to claim 65, wherein the capture system is configured to initially take a stowed launch position, in which each foldable sheet-like structure takes a corresponding stowed configuration, and to be subsequently switched to a standby position, in which each foldable sheet-like structure takes the standby configuration, and wherein the closing mechanism is configured to cause switching of the capture system from the stowed launch position to the standby position by pivotal movement of each deployment unit.

71. The capture system according to claim 70, wherein each deployment unit further comprises a retaining mechanism configured to hold the foldable sheet-like structures in the stowed configuration.

72. The capture system according to claim 71, wherein the retaining mechanism comprises one or more retaining members each configured to hold a selected portion of the foldable sheet-like structures in the stowed configuration, each retaining member being configured to automatically release the selected portion of the foldable sheet-like structures upon switching from the stowed configuration to the standby configuration.

73. The capture system according to claim 71, wherein the retaining mechanism comprises one or more finger members each configured to maintain a selected portion of the foldable sheet-like structures in the stowed configuration.

74. The capture system according to claim 73, wherein each finger member is further configured to assist switching of the foldable sheet-like structures from the stowed configuration to the standby configuration.

75. The capture system according to claim 46, further comprising a sensor system designed to assist tracking and rendezvous operations with the selected orbital object.

76. The capture system according to claim 75, wherein the sensor system is located in a central portion of the deployment platform along a centreline of the capture structure.

77. The capture system according to claim 76, wherein the standby configuration is an open configuration, in which the closing mechanism is operated to open the capture structure and so that the capture structure does not obstruct a field of view of the sensor system.

78. The capture system according to claim 77, wherein a distal end of each deployable boom is provided with a holding member comprising first and second arms that are configured to hold an associated pair of said foldable sheet-like structures in the standby configuration and prevent obstruction of the field of view of the sensor system,
wherein the first arm of the holding member is configured to hold a first upper portion of a first foldable sheet-like structure of said associated pair of foldable sheet-like structures in the standby configuration,
and wherein the second arm of the holding member is configured to hold a second upper portion of a second foldable sheet-like structure of said associated pair of foldable sheet-like structures in the standby configuration.

79. The capture system according to claim 46, wherein each foldable sheet-like structure is made of a sheet or foil of flexible material.

80. The capture system according to claim 79, wherein each foldable sheet-like structure is made of polyimide material, such as Kapton, or of polyethylene terephthalate (PET) material, in particular biaxially-oriented polyethylene terephthalate (BoPET) material, such as Mylar.

81. The capture system according to claim 46, wherein each foldable sheet-like structure is coated for protection against corrosion by atomic oxygen (ATOX).

82. The capture system according to claim 81, wherein each foldable sheet-like structure is aluminium coated.

83. The capture system according to claim 46, wherein a thickness of each foldable sheet-like structure is comprised between 100 μm and 150 μm.

84. A spacecraft comprising a capture system in accordance with claim 46.

85. The spacecraft according to claim 84, wherein the capture system is located on the X+ face of the spacecraft.

86. A method of capturing an orbital object by means of a spacecraft in accordance with claim 84, comprising the following steps:
(a) operating the capture system to bring the capture structure to the standby configuration;
(b) locating a selected orbital object to be captured and manoeuvring the spacecraft to perform a rendezvous with the selected orbital object;
(c) operating the capture system to bring the capture structure to the fully deployed open configuration;
(d) manoeuvring the spacecraft to bring the selected orbital object inside the capture volume of the capture structure;
(e) operating the capture system to close the capture structure;
operating the capture system to retract the capture structure;
(g) checking proper capture of the selected orbital object by the capture system; and
(h) in case of a capture failure, operating the capture system to open the capture structure and repeating steps (c) to (h).

87. The method according to claim 86, wherein, prior to a first capture attempt, the deployment platform is operated at step (c) to bring the capture structure from the standby configuration to a partly deployed open configuration and then from the partly deployed open configuration to the fully deployed open configuration,
wherein the closing mechanism is operated at step (e) to bring the capture structure from the fully deployed open configuration to a fully deployed closed configuration,
wherein the deployment platform is operated at step (f) to bring the capture structure from the fully deployed closed configuration to a partly retracted closed configuration,
and wherein, in case of capture failure, the closing mechanism is operated at step (h) to bring the capture structure from the partly retracted closed configuration back to the partly deployed open configuration.

88. The method according to claim 86, wherein, during launch of the spacecraft, the capture system is initially configured to take a stowed launch position, in which each foldable sheet-like structure takes a corresponding stowed configuration,
and wherein the capture system is subsequently reconfigured to switch the capture system from the stowed launch position to a standby position, in which each foldable sheet-like structure takes the standby configuration.

89. A method of deorbiting an orbital object comprising:
capturing the orbital object by means of a spacecraft in accordance with the method of claim 86; and
manoeuvring the spacecraft to deorbit the captured orbital object.

90. A method of operating a deployable capture structure to capture orbital objects, which capture structure consists of a capture envelope comprising a plurality of foldable sheet-like structures each configured to be reversibly foldable and unfoldable as a function of deployment of the capture structure, each foldable sheet-like structure being designed to take a first configuration, in which the foldable sheet-like structure is folded on itself to form a standby configuration of the capture structure, and at least a second configuration, in which the foldable sheet-like structure is unfolded and extended to form a fully deployed open configuration of the capture structure,
each foldable sheet-like structure exhibiting a fold pattern defining an alternation of convex and concave sections in the second configuration, which convex and concave sections are adapted to automatically fold one on top of the other upon retracting the capture structure.
